(19) United States
(12) Patent Application Publication
(10) Pub. No.: US 2008/0074535 A1
(43) Pub. Date: Mar. 27, 2008

(54) IMAGING APPARATUS

(76) Inventors: Jun Ohsuga, Kawasaki-shi (JP); Kazuhiro Yoshida, Yokohama-shi (JP); Yoshio Serikawa, Kasukabe-shi (JP)

Correspondence Address: DICKSTEIN SHAPIRO LLP, 1825 EYE STREET NW, Washington, DC, 20006-5403, US

(21) Appl. No.: 11/855,946

(22) Filed: Sep. 14, 2007

(30) Foreign Application Priority Data
Sep. 15, 2006 (JP) 2006-251941

(51) Int. Cl. H04N 5/222; G08B 19/00

(52) U.S. Cl. 348/371; 340/635

(57) ABSTRACT

An imaging apparatus includes a semiconductor light-emitting device functioning as a strobe light having a current limitation unit for limiting current to flow to the semiconductor light-emitting device. The current limitation unit limits current to flow to the semiconductor light-emitting device under a predetermined condition for increasing a current consumption amount.

### PRIORITY CLAIM

The present application is based on and claims priority from Japanese Application Number 2006-251941, filed on Sep. 15, 2006, the disclosure of which is hereby incorporated by reference herein in its entirety.

### BACKGROUND OF THE INVENTION

1. Field of the Invention

The present invention relates to an imaging apparatus such as a digital camera which takes and reproduces electronic images.

2. Description of Related Art

In a general strobe light device used for a camera, electric charges are stored in a capacitor, and a xenon tube is caused to emit light in accordance with a light emission control signal. Meanwhile, in recent years, semiconductor light-emitting devices such as a white LED and superluminescent LEDs of R, G and B, which are light's three primary colors, have been introduced. Accordingly, an LED is more likely to be used for a strobe light.

When an LED is used for a strobe light, an imaging apparatus does not require a complicated circuit configuration and a huge capacitor, which have been needed for a conventional device. This results in an achievement of the downsizing of apparatuses. In addition, since the device does not need time for charging the capacitor, it is possible to sequentially take images with strobe light. Moreover, in a case of using LEDs of three colors of R, G and B, white light can be generated by combining light beams of the three colors. Thus, a white LED can be composed of the LEDs of three colors. Moreover, the light emission amount of each of the LEDs can be changed by changing a current amount to be supplied to each of the LEDs. Accordingly, using the LEDs of three colors of R, G and B enables generation of various hues of light. On the other hand, in the case of using the LEDs of three colors, current needs to be supplied to each of the LEDs. In particular, in order to obtain the light amount necessary for the strobe light function, a large amount of current needs to be supplied to each of the LEDs. As such, there are still many problems to be solved in order to put the LEDs of three colors into practical use as a strobe light.

As a method of operating an LED strobe light, Japanese Patent Application Laid-open Publication No. 2003-158675 (called Patent Document 1, below) discloses a method of controlling an amount of light emitted from a white LED in accordance with image information. This method adopts the same idea as that for a conventional strobe light circuit employing a xenon tube. In this method, information on subject brightness and the like is obtained from image information, and the light amounts of the LEDs are controlled in accordance with the information thus obtained.

Although the conventional strobe light circuit employing the xenon tube disclosed in Patent Document 1 emits light by using electric charges stored in the capacitor, the LED strobe light draws current from a battery when operating for light emission. For this reason, if the light emission amount is determined only in accordance with the image information as similar to the conventional device, a current consumption peak occurs when the LED strobe light operation and the operations of a motor and a memory, each of which requires a large amount of current consumption, are driven at the same time. In particular, a portable apparatus such as a digital camera driven with a battery has a limitation on current to be supplied thereto. Accordingly, even when an apparatus requires an amount of current larger than that of a battery supply current, the required amount of current cannot be supplied from the battery to the apparatus, which may stop all the operations in the apparatus, as a whole. In order to prevent such a system down, it is important to prevent an occurrence of the current consumption peak by avoiding a situation in which operations each requiring a large amount of current consumption are carried out at the same time.

In addition, when the current consumption becomes large as described above, that is, when a large load is applied to a power source, the voltage of the power source shifts due to the load change. More specifically, when the voltage of the power source shifts during an exposure time of a solid state imaging device, a time when a bias voltage is applied or a time when the solid state imaging device transfers an image signal, the solid state imaging device is subjected to the fluctuation of the voltage of the power source and the bias voltage applied thereto. This results in deterioration of image quality, and also leads to even a failure in obtaining an image, itself, in the worst case.

However, in the conventional technique disclosed in Japanese Patent Application laid-open Publication No. 2001-215579 (called Patent Document 2), it is considered that light is flashed in synchronization with a timing of imaging in a case where an image is taken by using a semiconductor light-emitting device or a lighting unit such as a lamp, but the aforementioned problems are not considered.

### SUMMARY OF THE INVENTION

An object of the present invention is to provide an imaging apparatus which employs a semiconductor light-emitting device as a strobe light, and which is capable of a long-time operation by saving power consumption without causing a current consumption peak when the strobe light employing a semiconductor light-emitting device is used.

According to an embodiment of the present invention to achieve the foregoing object, an imaging apparatus having a semiconductor light-emitting device functioning as a strobe light includes a current limitation unit for limiting a current to be supplied to the semiconductor light-emitting device. The current limitation unit limits the current to be supplied to the semiconductor light-emitting device under a predetermined condition for increasing a current consumption amount.

In addition, according to an embodiment of the present invention to achieve the forgoing object, an imaging apparatus having a plurality of semiconductor light-emitting devices functioning as a strobe light includes a light emitting device controlling unit for controlling the number of semiconductor light-emitting devices to emit light among the plurality of semiconductor light-emitting devices. The light emitting device controlling unit controls the number of semiconductor light-emitting devices to emit light under a predetermined condition for increasing a current consumption amount.

The predetermined condition is preferably a motor driving time.

The predetermined condition is preferably a memory operating time.

The predetermined condition is preferably a communication operating time.

The predetermined condition is preferably a time when a remaining battery capacity is low.

Furthermore, according to an embodiment of the present invention to achieve the foregoing object, an imaging apparatus includes: an imaging unit for picking up an image of a subject with a solid state imaging device; a lighting unit for lighting a subject; a controlling unit for controlling an operation of each of the imaging unit and the lighting unit; and a power supply unit for supplying power to at least the imaging unit, the lighting unit and the controlling unit. The controlling unit controls a change of a load on the lighting unit in order to prevent deterioration of image quality of an image obtained by the imaging unit.

The controlling unit preferably changes power supply to the lighting unit through multiple levels.

The controlling unit preferably changes a power supply time for supplying power to the lighting unit, according to a power source state of the power supply unit.

The controlling unit preferably changes the power supply time for supplying power to the lighting unit, according to an ambient temperature.

The controlling unit preferably changes the power supply time for supplying power to the lighting unit, according to a condition of a load on the power supply unit.

The controlling unit preferably changes the power supply time for supplying power to the lighting unit by using a predetermined control method.

The controlling unit preferably changes the power supply time for supplying power to the lighting unit while monitoring a change of a load on the lighting unit.

The controlling unit preferably changes the power supply time for supplying power to the lighting unit while monitoring a change of a load on the power supply unit.

The controlling unit preferably controls power supply to the lighting unit so that the power supply would not start or stop while the imaging unit is picking up an image.

The controlling unit preferably controls power supply to the lighting unit so that the power supply would not start or stop while the imaging unit is transferring an image.

### BRIEF DESCRIPTION OF THE DRAWINGS

FIG. 1A is a plan view schematically showing a digital camera that is an imaging apparatus according to an embodiment of the present invention.

FIG. 1B is a front view schematically showing the digital camera according to the embodiment of the present invention.

FIG. 1C is a back view schematically showing the digital camera according to the embodiment of the present invention.

FIGS. 2A to 2D are a block diagram schematically showing the digital camera according to the embodiment of the present invention.

FIG. 3 is a flowchart showing a general sequence of recording moving images.

FIG. 4 is a timing chart at a recording time.

FIG. 5 is a timing chart of moving image recording obtained by adding an LED strobe lighting operation and a zooming operation to the timing chart in FIG. 4.

FIG. 6 is a flowchart in a case where an LED strobe lighting unit is caused to emit light while the current to be supplied to the LED strobe lighting unit is limited under a predetermined condition.

FIG. 7 is a table showing relationships between predetermined conditions and weighting.

FIG. 8 is a table showing current to be supplied to an LED strobe lighting unit.

FIG. 9 is a circuit diagram showing a configuration of a current controlling unit.

FIG. 10A is a diagram showing a waveform of current flowing through the LED strobe lighting unit in a conventional case without current limitation.

FIG. 10B is a diagram showing a waveform of current flowing through the LED strobe lighting unit with current limitation.

FIG. 11 is a flowchart in a case where LEDs in the LED strobe lighting unit are caused to emit light while the number of light emitting LEDs is controlled under the predetermined conditions.

FIG. 12 is a circuit diagram showing a configuration of the light emitting LED controlling unit.

FIG. 13 is a diagram showing waveforms of current consumption in a conventional LED strobe light.

FIG. 14 is a block diagram schematically showing an imaging apparatus according to a second embodiment.

FIG. 15 is a graph showing a discharging characteristic of a battery.

FIG. 16A is a diagram showing one example of remaining battery capacity display marks.

FIG. 16B is a diagram showing one example of the remaining battery capacity display marks.

FIG. 16C is a diagram showing one example of the remaining battery capacity display marks.

FIG. 16D is a diagram showing one example of the remaining battery capacity display marks.

FIG. 16E is a diagram showing one example of the remaining battery capacity display marks.

FIG. 17 is a flowchart showing an operation of the digital camera according to the second embodiment.

FIG. 18 is a graph showing relationships between a battery voltage and a power supply time.

FIGS. 19A to 19D are a block diagram schematically showing a digital camera according to a third embodiment.

FIG. 20 is a flowchart showing an operation of a digital camera according to the third embodiment.

FIG. 21 is a diagram showing an example of a selection screen for requesting to select whether to discharge or to replace a battery.

FIG. 22 is a flowchart showing another operation of the digital camera according to the third embodiment.

FIG. 23 is a block diagram schematically showing a digital camera according to a fourth embodiment.

FIG. 24 is a diagram showing a timing chart of each unit in the digital camera according to the fourth embodiment.

FIG. 25 is a diagram showing a timing chart of each unit in the digital camera according to the fourth embodiment.

FIG. 26 is a block diagram schematically showing a main configuration in a digital camera according to a fifth embodiment.

FIG. 27 is a diagram showing an example of a battery-voltage reading circuit.

FIG. 28 is a diagram showing an example of a circuit configuration of a power supply voltage divider circuit.

FIG. 29 is a diagram showing another example of the circuit configuration of the power supply voltage divider circuit.

FIG. 30 is a flowchart showing an operation of a digital camera according to the fifth embodiment.

### DETAILED DESCRIPTION OF THE PREFERRED EMBODIMENTS

Hereinafter, preferred embodiment of the present invention will be described in detail with reference to the accompanying drawings.

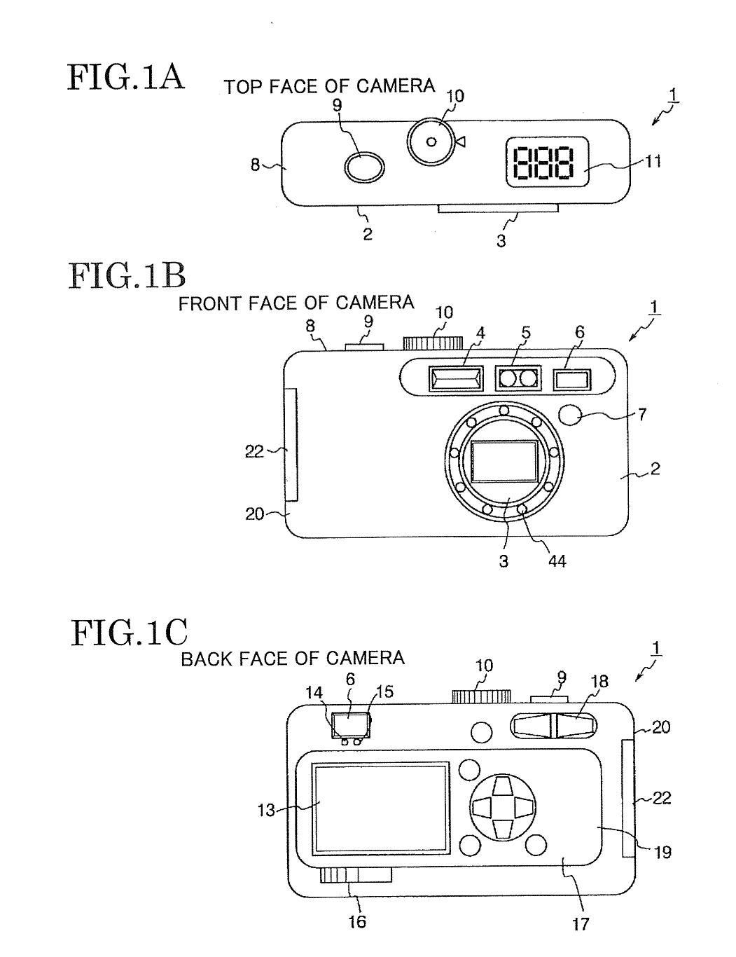

Each of FIGS. 1A to 1C shows a digital camera 1 according to this embodiment of the present invention. Note that the digital camera 1 of this embodiment includes not only an LED strobe lighting unit 44 but also a conventional strobe light emitting unit 4. However, the present invention is not limited to this structure.

A camera cone unit 3 is provided at a central portion of a front face 2 of the digital camera 1, and allows light for shooting to enter the digital camera 1. Moreover, as shown in FIG. 1B, a strobe light emitting unit 4, a range finder unit 5 and an optical finder 6 are provided above the camera cone unit 3 in the front face 2 of the digital camera 1. The strobe light emitting unit 4 emits light to a subject. The range finder unit 5 is for measuring a distance to the subject when the user focuses on the subject with an autofocus (AF) function. The optical finder 6 is used by a user, when the user visually checks a photographing range and the like. In addition, a remote-controller-light receiving unit 7 is provided below the optical finder 6 in the front face 2 of the digital camera 1, and receives a light signal from a remote controller which is not shown in FIGS. 1A to 1C. Additionally, the LED strobe lighting unit 44 is disposed so as to surround the camera cone unit 3 in the front face 2 of the digital camera 1, and has multiple LEDs for emitting light to a subject, as similar to the strobe light emitting unit 4.

As shown in FIG. 1A, a release button 9, a mode dial 10 for switching image taking modes, and a sub-LCD 11 for displaying the number of remaining shootable images are provided to a top face 8 of the digital camera 1. Moreover, as shown in FIG. 1C, an LCD 13, an AF-LED 14, a strobe light LED 15, a power switch 16 and an operation button unit 17 are provided to a back face 12 of the digital camera 1. The LCD 13 displays picked-up images and the like, the AF-LED 14 displays an AF status at a time of photographing, the strobe light LED 15 displays a charging status of the strobe light, the power switch 16 switches on/off of the power supply of the digital camera 1, and the operation button unit 17 is used to make operational instructions and various settings from the outside. The operation button unit 17 is provided with a zoom button 18 for setting a zoom factor.

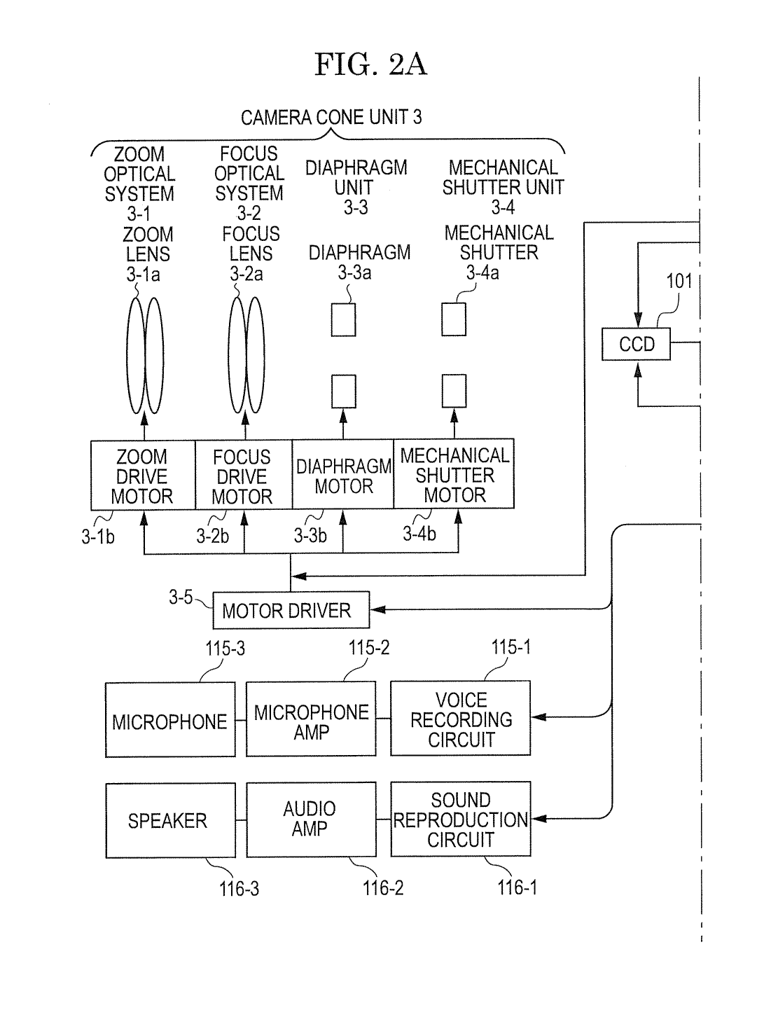

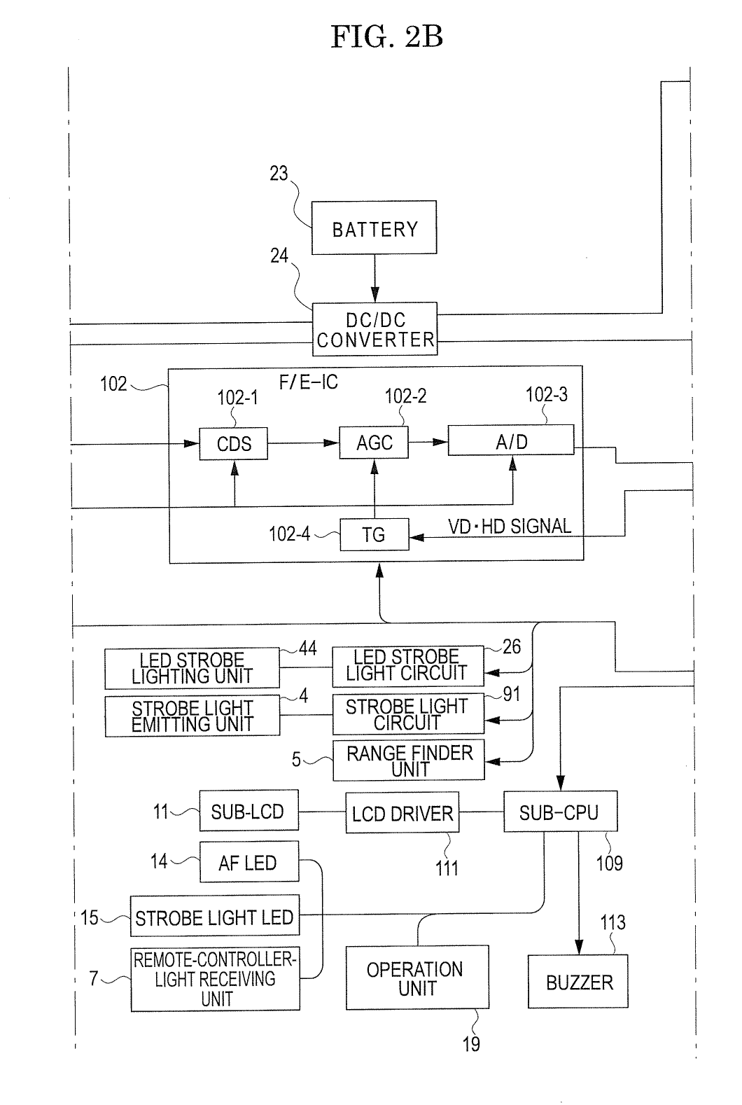

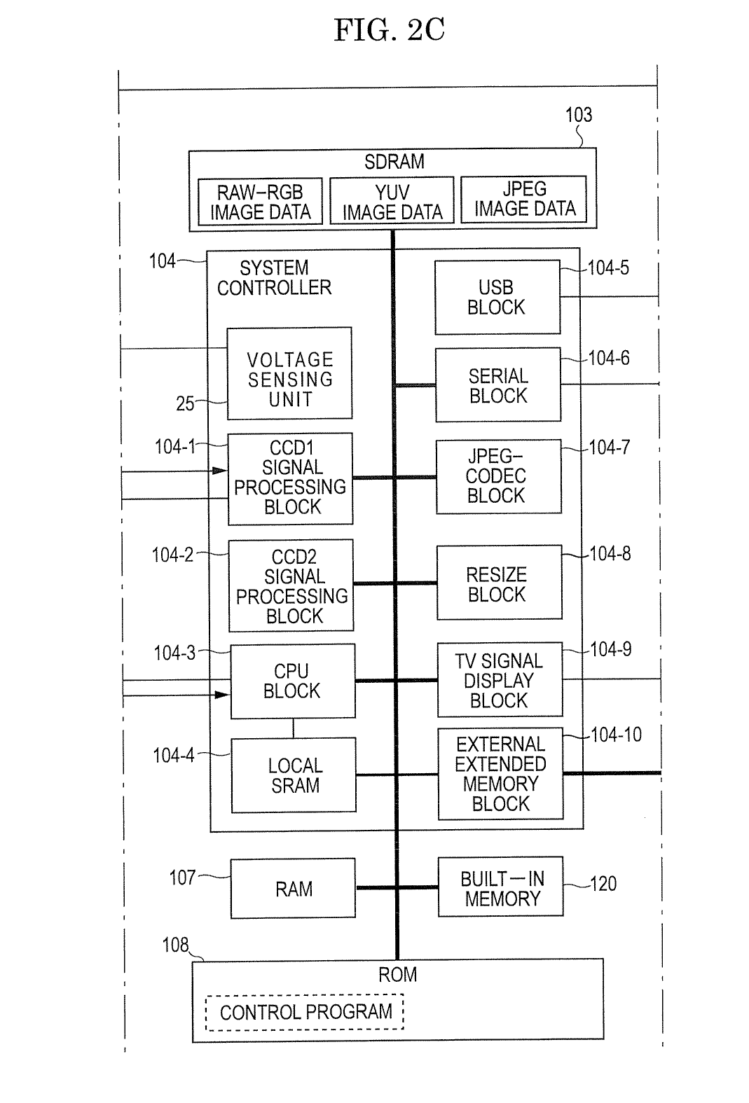

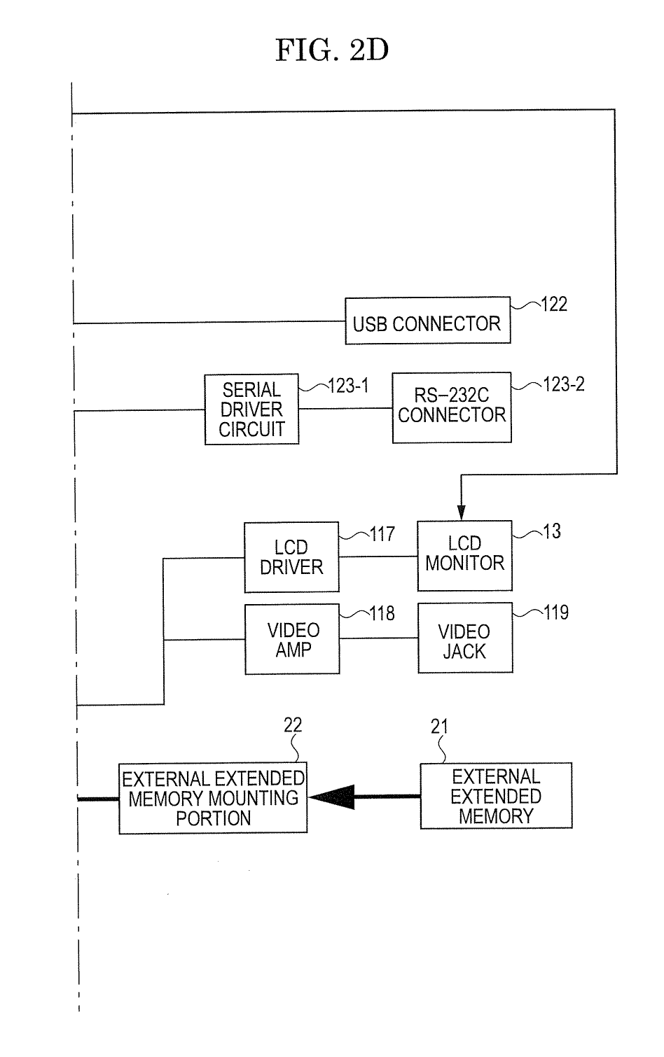

The AF-LED 14 and the strobe light LED 15 are also used to display statuses other then the charging status of the strobe light, for example, a status in which an external extended memory 21 (see FIGS. 2A to 2D) is accessing the digital camera 1. Note that, the release button 9, the mode dial 10, the power switch 16 and the operation button unit 17 constitute an operation unit 19. In addition, an external extended memory mounting portion 22 is provided to a side face 20 of the digital camera 1. On the external extended memory mounting portion 22, the external extended memory 21 (see FIGS. 2A to 2D) such as a memory card is mounted detachably. In addition, a battery mounting portion, which is not illustrated, is provided inside the digital camera 1, and a battery 23 (see FIGS. 2A to 2D) is detachably mounted on the battery mounting portion.

FIGS. 2A to 2D is a block diagram schematically showing a configuration of the digital camera 1. As shown in FIG. 2A to 2D, the camera cone unit 3 is mainly composed of a zoom optical system 3-1, a focus optical system 3-2, a diaphragm unit 3-3, a mechanical shutter unit 3-4 and a motor driver 3-5. The zoom optical system 3-1 includes a zoom lens 3-1a as a driven member for capturing an optical image of a subject, and a zoom drive motor 3-1b as a motor. The focus optical system 3-2 includes a focus lens 3-2a and a focus drive motor 3-2b. The diaphragm unit 3-3 includes a diaphragm 3-3a and a diaphragm motor 3-3b. The mechanical shutter unit 3-4 includes a mechanical shutter 3-4a and a mechanical shutter motor 3-4b. The motor driver 3-5 drives direct-current motors such as the zoom drive motor 3-1b, the focus drive motor 3-2b, the diaphragm motor 3-3b and the mechanical shutter motor 3-4b.

A CCD 101 is a solid state imaging device for performing a photoelectric conversion (analog signal conversion) of an optical image captured from the camera cone unit 3. An F/E (front end)-IC 102 includes a CDS (correlated double sampling) 102-1 that performs correlated double sampling for reducing noise in an image, and an AGC (auto gain controller) 102-2 for adjusting a gain. Additionally, the F/E (front end)-IC 102 includes an A/D 102-3 for performing a digital signal conversion, and a TG (timing generator) 102-4. The TG (timing generator) 102-4 generates a drive timing signal upon receipt of a vertical sync signal (VD signal) and a horizontal sync signal (HD signal) from a CCD1 signal processing block 104-1 of a system controller 104, which will be described below.

The system controller 104 as a controlling unit includes the CCD1 signal processing block 104-1, a CCD2 signal processing block 104-2, a CPU block 104-3, a local SRAM 104-4 and a USB block 104-5. Moreover, the system controller 104 includes a serial block 104-6, a JPEG-CODEC block 104-7, a RESIZE block 104-8, a TV signal display block 104-9 and an external extended memory block 104-10. The CCD1 signal processing block 104-1 makes a white balance setting and a gamma setting for digital image data inputted from the CCD 101 via the F/E-IC 102 and outputs the VD signal and the HD signal as described above. The CCD2 signal processing block 104-2 performs filtering processing to convert the image data into brightness data and chroma data. The CPU block 104-3 controls the operation of each of components, such as the motor driver 3-5 and the CCD 101, of the digital camera 1 in accordance with a below-described control program stored in a ROM 108, in response to signals inputted from the remote-controller-light receiving unit 7 and the operation unit 19. Data required by the CPU block 104-3 to make the control are temporarily stored in the local SRAM 104-4. The USB block 104-5 performs USB communications with an external apparatus such as a PC. The serial block 104-6 performs serial communications with an external apparatus such as a PC. The JPEG-CODEC block 104-7 performs JPEG compression and expansion. The RESIZE block 104-8 enlarges and reduces the size of image data by performing interpolation. The TV signal display block 104-9 converts the image data into video signals for displaying the image data on an external display apparatus such as the LCD 13 or a TV set. The external extended memory block 104-10 controls the external extended memory 21 such as a memory card for recording picked-up image data.

In the ROM 108, stored are the control program described with codes that can be decoded by the CPU block 104-3, the data required by the CPU block 104-3 to control the operations of the digital camera 1, and the like.

When the digital camera 1 is powered on by operating the power switch 16, the control program stored in the ROM 108 is loaded to a main memory, which is not illustrated. In addition, when the digital camera 1 is powered on by operating the power switch 16, the CPU block 104-3 controls the operation of each unit in the digital camera 1 in accordance with the control program, and temporarily stores data necessary for the control in the RAM 107 and the local SRAM 104-4. Incidentally, in a case where the ROM 108 is conFIGured of a rewritable flash ROM, it is possible to change parameters and the like necessary for the control program and the control. With this configuration, the functions of the digital camera 1 can be easily updated.

An SDRAM 103 temporarily stores image data used during various kinds of processing by the system controller 104. Examples of the stored image data are: RAW-RGB image data which are captured into the CCD1 signal processing block 104-1 from the CCD 101 via the F/E-IC 102, and which have the white balance and gamma set by the CCD1 signal processing block 104-1; YUV image data obtained by converting the image data into the brightness data and the chroma data by the CCD2 signal processing block 104-2; JPEG image data obtained by performing the JPEG compression of the image data by the JPEG-CODEC block 104-7; and the like.

A built-in memory 120 is capable of memorizing picked-up image data even when the external extended memory 21 such as a memory card is not mounted on the external extended memory mounting portion 22.

The LCD driver 117 drives the LCD 13 and converts a video signal outputted from the TV signal display block 104-9 into a signal for displaying the video signal on the LCD 13. This enables a user to observe the state of a subject before picking up an image, to check a picked-up image, and to view image data stored in the external extended memory 21 and the built-in memory 120 by watching the LCD 13.

A video AMP 118 is an amplifier for converting the impedance of the video signal outputted from the TV signal display block 104-9 into 75Ω. A video jack 119 is a jack to be connected to an external display apparatus such as a TV set. A USB connector 122 is a connector for connecting the digital camera 1 to an external apparatus such as a PC via USB. A serial driver circuit 123-1 is a circuit for converting the voltage of an output signal from the serial block 104-6 in order for the digital camera 1 to perform serial communications with an external apparatus such as a PC. An RS-232C connector 123-2 is a connector for connecting the digital camera 1 to a serial port of an external apparatus such as the PC.

A sub-CPU 109 is a CPU incorporated in a chip together with a ROM, a RAM and the like, and causes signals outputted from the remote-controller-light receiving unit 7 and the operation unit 19 to be outputted to the CPU block 104-3 as information on operations by the user. In addition, the sub-CPU 109 converts a signal, outputted from the CPU block 104-3 and indicating a state of the digital camera 1, into control signals for the sub-LCD 11, the AF-LED 14, the strobe light LED 15, a buzzer 113 and the like, and then outputs the resultant signals to the corresponding components. A LCD driver 111 is a drive circuit for driving the sub-LCD 11 in accordance with the signals outputted from the sub-CPU 109.

A voice recording unit includes a microphone 115-3 used by the user to input voice signals, a microphone AMP 115-2 and a voice recording circuit 115-1. The microphone AMP 115-2 amplifies the voice signals inputted to the microphone 115-3. The voice recording circuit 115-1 records the voice signals amplified by the microphone AMP 115-2. In addition, a sound reproduction unit includes a sound reproduction circuit 116-1, an audio AMP 116-2 and a speaker 116-3. The sound reproduction circuit 116-1 converts the recorded voice signals into signals for outputting the voice signal from the speaker 116-3, which will be described below. The audio AMP 116-2 amplifies the resultant voice signals after the conversion by the sound reproduction circuit 116-1, and drives the speaker 116-3. The speaker 116-3 outputs the voice signals amplified by the audio AMP 116-2.

A power supply circuit of the digital camera 1 is formed by a DC/DC converter (power supply unit) 24 and the system controller (driving voltage controlling unit) 104. The system controller 104 controls the operations of the power supply circuit. In accordance with the control by the system controller 104, power is supplied from the battery 23 via the DC/DC converter 24 to the direct current motors such as the zoom drive motor 3-1b, the focus drive motor 3-2b, the diaphragm motor 3-3b and the mechanical shutter motor 3-4b, and each of the components such as the system controller 104, the CCD 101, the LCD 13 and the F/E-IC 102 of the digital camera 1. The DC/DC converter 24 has a function of shifting the level of a voltage to be applied to each component, depending on the component to be supplied with power from the battery 23. A voltage sensing unit 25 performs the A/D conversion of a battery voltage at certain intervals. The CPU block 104-3 compares the resultant battery voltage after the A/D conversion by the voltage sensing unit 25, with a threshold value stored in the ROM 108. If the battery voltage is smaller than the threshold voltage, the CPU block 104-3 performs processing for changing the display of the remaining battery capacity on the LCD 13 or the sub-LCD 11, or processing for terminating the operations of the apparatus.

### First Embodiment

Hereinafter, descriptions will be provided for a first embodiment of the digital camera 1 configured as described above.

Firstly, a general sequence of recording moving images will be described.

This embodiment shows an example of the digital camera 1 at a time of recording moving images, for the purpose of showing that the digital camera 1 according to this embodiment more surely produces an effect when using the LED strobe lighting unit 44 while recording moving images. However, the application of the present invention is not limited to a time of recording moving images, and the present invention can be also used at a time of picking up a still image.

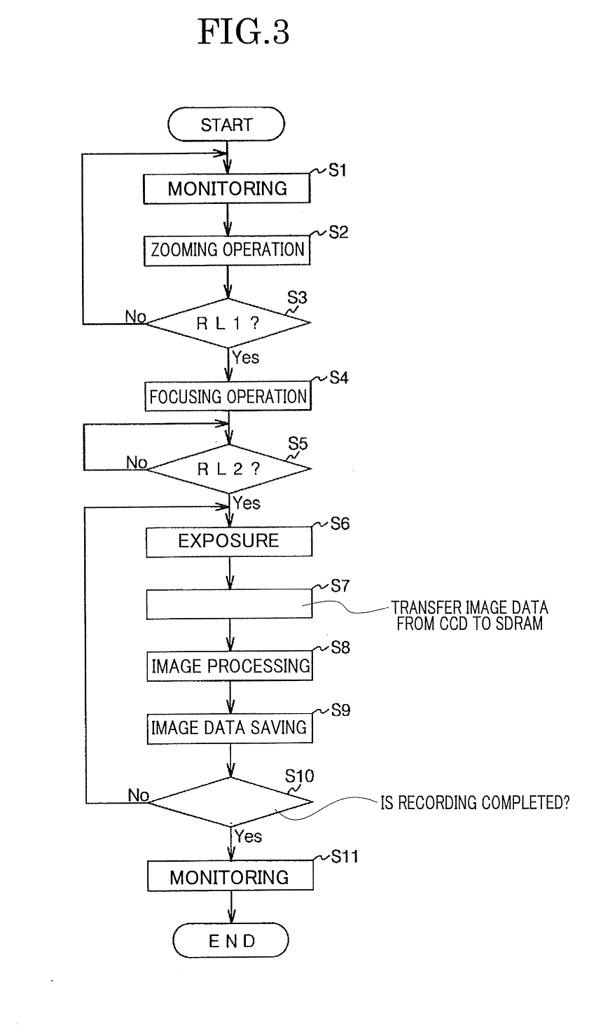

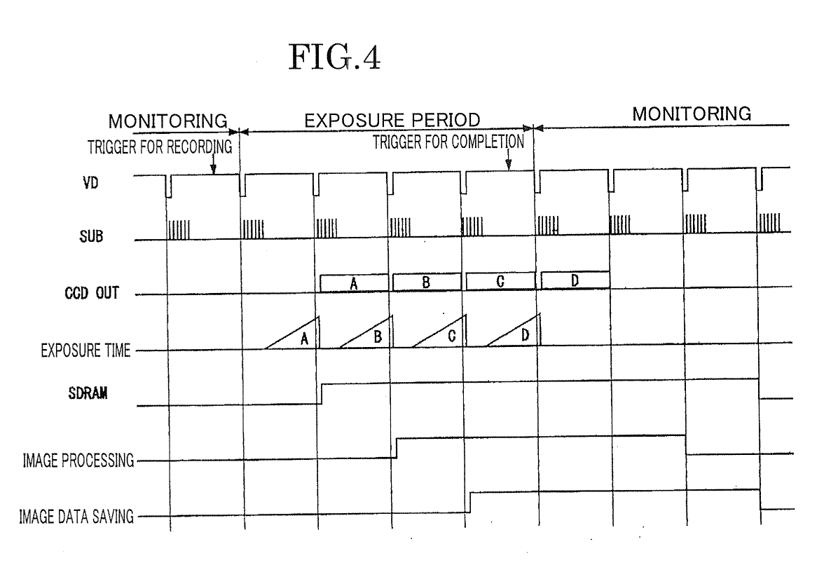

FIG. 3 is a flowchart showing the general sequence of recording moving images. FIG. 4 is a diagram showing a timing chart at the recording time. The sequence of recording moving images with the digital camera 1 of this embodiment will be described by referring to FIG. 3.

When the digital camera 1 of this embodiment records moving images, monitoring is firstly performed (step S1). Subsequently, in this monitoring status, a user moves the zoom lens 3-1a by operating the zoom button 18 so that a subject can be positioned within the screen (step S2). After determining the composition of moving images by moving the zoom lens 3-1a, the user presses the release button 9 halfway down to cause the release button 9 to be in a state of release 1 (RL1) (step S3). When the release button 9 becomes in the RL1 state, the focus lens 3-2a moves to focus on the subject image (step S4). After the subject image is focused on, the user presses down the release button 9 fully to change the release button 9 from the RL1 state to an RL2 state (step S5). The event in which the release button 9 becomes in the RL2 state generates a trigger of recoding moving images, and thereby exposure of the CCD 101 starts (step S6). The image data captured by the CCD 101 through the exposure of the CCD 101 are transferred from the CCD 101 to the SDRAM 103 (step S7). Next, image processing is executed on the image data transferred to the SDRAM 103 in the system controller 104 (step 8), and then the processed image data are stored in the built-in memory 120 or the external extended memory 21 (step S9). Since the recording of moving images is temporally continuous recording, the operations from step S6 to step S9 are repeated unless the user makes an instruction to stop recording by pressing the release button 9 once again, for example. Thereafter, upon receipt of the instruction to stop recording (step S10), the digital camera 1 terminates recording and returns to the monitoring state (step S11).

Hereinafter, descriptions will be provided for timings of the exposure, the image processing and the image saving.

The digital camera 1 performs the recording operation in synchronization with the vertical sync signals (VD). A SUB pulse is a signal outputted from the TG 102-4 to the CCD 101. The SUB pulse has an electric shutter function. Accordingly, while the SUB pulses are outputted, the CCD 101 is not exposed since the electric charge accumulated in a photodiode of the CCD 101 is discharged to the substrate. The number of outputted SUB pulses is controlled according to the result of the photometry of the subject. Once a recoding trigger to start recording is generated by a user's operation of the release button 9, the exposure starts in synchronization with the vertical sync signal (VD) (an exposure period A). The image data accumulated in the photodiode of the CCD 101 in the exposure period A are outputted from the CCD 101 in synchronization with the next VD subsequently outputted after the VD at the time when the exposure period A starts. The image data outputted from the CCD 101 are subjected to the gamma processing and the white balance processing in the CCD1 signal processing block 104-1 of the system controller 104. The image data obtained by performing the gamma processing and the white balance processing are converted into brightness and chroma (YUV) data in the CCD2 signal processing block 104-2, and then are transferred to the SDRAM 103. Then, the size of the image data transferred to the SDRAM 103 is changed in the RESIZE block 104-8 in synchronization with the next VD outputted after the VD at the time when the image data are outputted from the CCD 101, and then the image data are compressed with the JPEG compression in the JPEG-CODEC block 104-7. After that, in synchronization with the next VD, the image data are saved in the built-in memory 120 or the external extended memory 21 in conformity with a moving image format (for example, mov, avi and the like). As for the image processing, the gamma correction, the white balance setting and the YUV conversion are preformed while the image data are transferred from the CCD 101 to the SDRAM 103. However, in order to simplify the explanation, the example shown in FIG. 4 includes, as the image processing, only the processing for changing the image size and for JPEG compression. In the example in FIG. 4, exposure periods B, C and D sequentially starts in synchronization with the VDs sequentially outputted after the VD is outputted at the time of starting the exposure period A. The image data captured by the CCD 101 in each of the exposure periods B, C and D are processed and saved as similar to the image data captured by the CCD 101 in the exposure period A. Note that, although the example in FIG. 4 includes the four exposure periods A to D, the number of exposure periods can be appropriately changed according to the situation, because the exposure is repeated until the user presses the release button 9 to generate a termination trigger to stop recording. The aforementioned operations are operations in a general recording sequence.

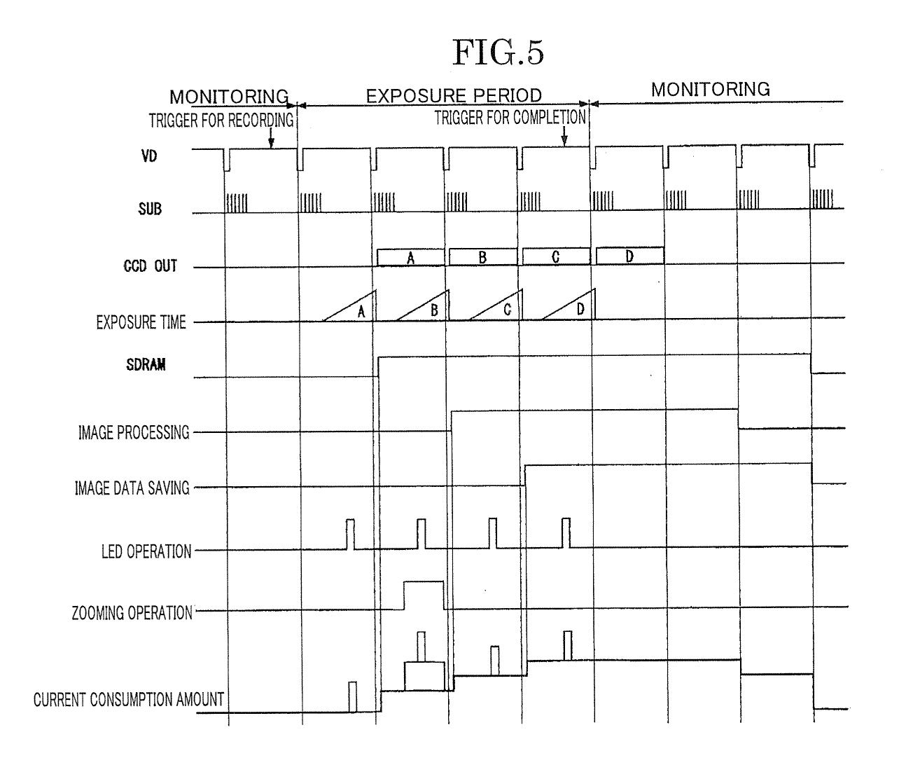

FIG. 5 shows a timing chart obtained by adding an LED strobe light operation and a zooming operation to the timing chart of recording moving images.

Assuming that the subject brightness is constant in the exposure periods, the same amount of current Ia flows into each of the LEDs in the LED strobe lighting unit 44 and the light is emitted for the same time Ta, as shown in FIG. 5, in the exposure periods A to D in the conventional example. With reference to a chart showing the current consumption amount in this case, it can be understood that the currents for both the LED strobe light operation and the zooming operation flow in addition to the current consumed (indicated by the bold line) for the memory operations (that is the operations of the SDRAM 103, the built-in memory 120 and the external extended memory 21) and the image processing in the system controller 104. In particular, current consumption peaks occur when the LED strobe light operation and the zooming operation are carried out at the same time, or when the memory operations, the image processing and the LED strobe light operation are carried out at the same time. In this way, a current consumption peak occurs in a case where the operation requiring a large amount of current consumption or multiple operations are carried out simultaneously with the LED strobe light operation.

Predetermined conditions for increasing the current consumption while the camera is in use are as follows.

[Predetermined Condition 1: Motor Operating Time]

The operations of the focus drive motor 3-2b of the focus optical system 3-2, the zoom drive motor 3-1b of the zoom optical system 3-1, the diaphragm motor 3-3b of the diaphragm unit 3-3 and the mechanical shutter motor 3-4b of the mechanical shutter unit 3-4 require the largest amount of current consumption among the operations of all components in the camera. In many cases, the zooming operation is allowed to be performed during the exposure periods. As a result, if the LED strobe lighting unit 44 and the zoom drive motor 3-1b are simultaneously operated in the exposure period, in particular, while moving images are recorded, a system down may occur due to shortage of power supply from the power supply unit. A predetermined condition 1 is such a motor operating time.

[Predetermined Condition 2: Memory Operating Time]

The SDRAM 103 is used as a place in which data for the image processing are temporarily recorded, and has such a high clock frequency that a large amount of image data can be written thereto and read therefrom at a high speed. For this reason, the SDRAM 103 needs a large amount of current to perform the memory operation. When moving images are recorded, in particular, the memory is accessed even more frequently since the image processing and image saving are carried out frequently. Moreover, a large amount of image data are written to and read from the built-in memory 120 and the external extended memory 21, which are used for saving images, at high speeds as is the case with the SDRAM 103. Consequently, when the built-in memory 120 or the external extended memory 21 is accessed, a large amount of current is also needed. A predetermined condition 2 is such a memory operating time.

[Predetermined Condition 3: Communication Operating Time]

An indispensable function of a digital camera in recent years is a communication function such as a function of transferring picked-up images to a PC or a printer. As communication methods, there are various communication methods using USB communications, wireless LAN, Bluetooth, a direct print system (DPS) and the like. When the communications are carried out, a large amount of current is needed for using a high-speed clock to transfer an image at a high speed. Moreover, the amount of current consumption is further increased when image data are read from a memory. A predetermined condition 3 is such a communication operating time.

[Predetermined Condition 4: Time of Low Remaining Battery Capacity]

In a portable apparatus using a battery as a power source, the battery voltage gradually decreases over operating time of the apparatus. Since the amount of power consumption in the apparatus is fixed, the amount of consumption of current drawn from the battery increases as the battery voltage decreases. A predetermined condition 4 is such a time when the remaining battery capacity is low. Incidentally, it may be judged that the predetermined condition 4 is satisfied in the following manner. Firstly, a threshold value is set for the battery voltage and is stored in the ROM 108. Then, the battery voltage obtained by the A/D conversion using the voltage sensing unit 25 is compared with the threshold value by the CPU block 104-3. Thus, it is judged that the predetermined condition 4 is satisfied when the battery voltage becomes lower than the threshold value.

By using the foregoing conditions 1 to 4 as the conditions for increasing the current consumption, descriptions will be given for a method of driving the LED strobe lighting unit 44 according to this embodiment.

[First Light Emission Sequence]

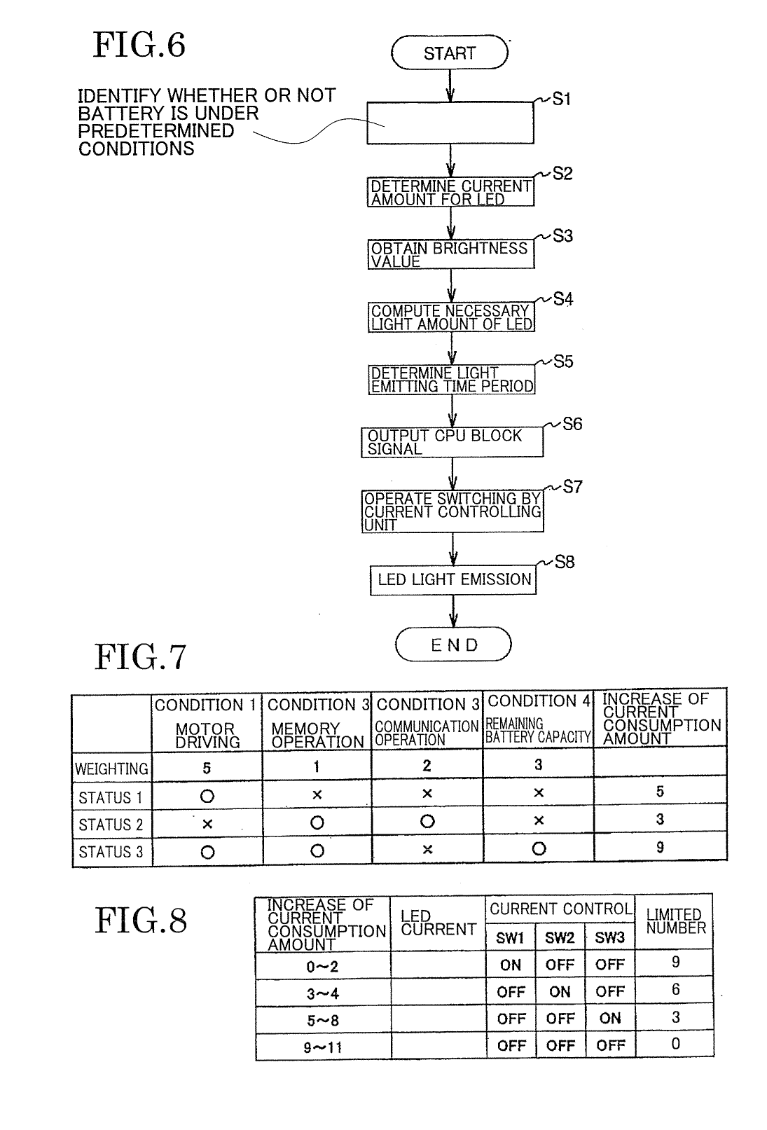

FIG. 6 is a flowchart in a case where each LED of the LED strobe lighting unit 44 is caused to emit light while the amount of current flowing to each LED is limited when the digital camera 1 is under any of the predetermined conditions 1 to 4. Firstly, a check is made to determine whether the digital camera 1 is under any of the aforementioned predetermined conditions 1 to 4 for increasing the amount of current consumption (step S1).

Each of the predetermined conditions 1 to 4 occurs individually in some cases, but two or more of the conditions 1 to 4 occur at the same time in other cases. Accordingly, as shown in FIG. 7, each of the predetermined conditions 1 to 4 may be weighted in proportion to the increasing amount of current consumption, and then the increasing amount of current consumption may be estimated according to the additional value obtained by summing up the values of weights assigned to currently-occurring conditions. Next, the amount of current to be supplied to each LED in the LED strobe lighting unit 44 is determined (step S2). In an example shown in FIG. 8, a value of LED current indicates an amount of current to be supplied to each LED in the LED strobe lighting unit 44, and is defined in advance in correspondence with the increasing amount of current consumption. Thus, the amount of LED current obtained in FIG. 7 in correspondence with the increasing amount of current consumption is determined, in accordance with the relationship between the amount of LED current and the increasing amount of current consumption. In a case where the increasing amount of current consumption is large (the case where the increasing amount of current consumption is 9 to 11 in the example of FIG. 8), forcible use of all the LEDs in the LED strobe lighting unit 44 may cause a system down due to shortage of power supply. To prevent this, in the shown example, a current limitation unit 50 is provided to an LED strobe light circuit 26, and this current limitation unit 50 limits the power supply amount to each LED in the LED strobe lighting unit 44.

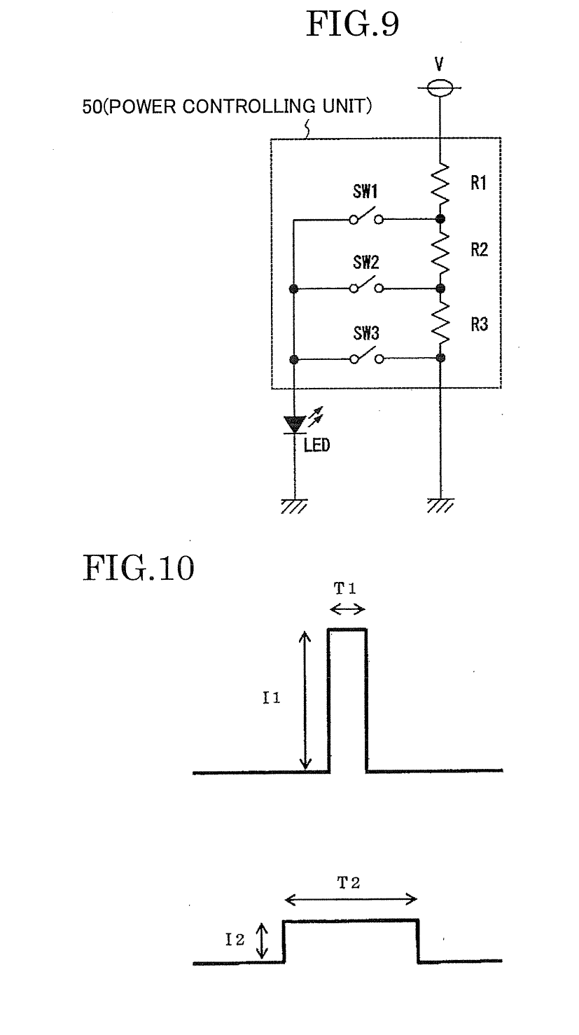

FIG. 9 is a diagram showing a circuit configuration of the current limitation unit 50. In an example shown in FIG. 9, the current limitation unit 50 is composed of three switches SW1, SW2 and SW3 and three resistances R1, R2 and R3. The current limitation unit 50 limits the amount of current to be supplied to each LED in the LED strobe lighting unit 44 by turning each of the switches SW1 to SW3 on or off in response to control signals transmitted from the CPU block 104-3 according to the definition in FIG. 8.

In the next step S3, the value of subject brightness before the exposure is obtained. Here, the subject brightness is obtained by the CCD 101 and a not-illustrated photometry sensor during a period between a time when a VD for starting the exposure is outputted, and a time when the VD immediately before the VD for starting the exposure is outputted.

Thereafter, the light amount necessary for each LED in the LED strobe lighting unit 44 is calculated from the value of the subject brightness obtained in step S3 (step S4).

Next, the light emission time is determined for each LED in the LED strobe lighting unit 44 (step S5).

FIG. 10A is a diagram showing a waveform of current flowing through each LED in the LED strobe lighting unit 44 in the conventional case where the current is not limited. FIG. 10B is a diagram showing a waveform of current flowing through each LED in the LED strobe lighting unit 44 when the current is limited.

When the current for each LED in the LED strobe lighting unit 44 is limited, the same light amount as that in FIG. 10A is obtained by setting the light emission time of each LED in the LED strobe lighting unit 44 to be longer than that in FIG. 10A, as shown in FIG. 10B. The light emission time for each LED in the LED strobe Lighting unit 44 is determined according to the current supply amount to each LED in the LED strobe lighting unit 44, which is determined in step S2, and the light amount necessary for each LED in the LED strobe lighting unit 44, which is calculated in step S4. Subsequently, a signal is outputted from the CPU block 104-3 to the current limitation unit 50 in the LED strobe light circuit 26 (step S6). In response to signals received from the CPU block 104-3, the current limitation unit 50 turns on or off each of the switches SW1 to SW3 (step S7). In this way, each LED in the LED strobe lighting unit 44 is caused to emit light while the amount of current flowing into the LED is limited (step S8).

[Second Light Emission Sequence]

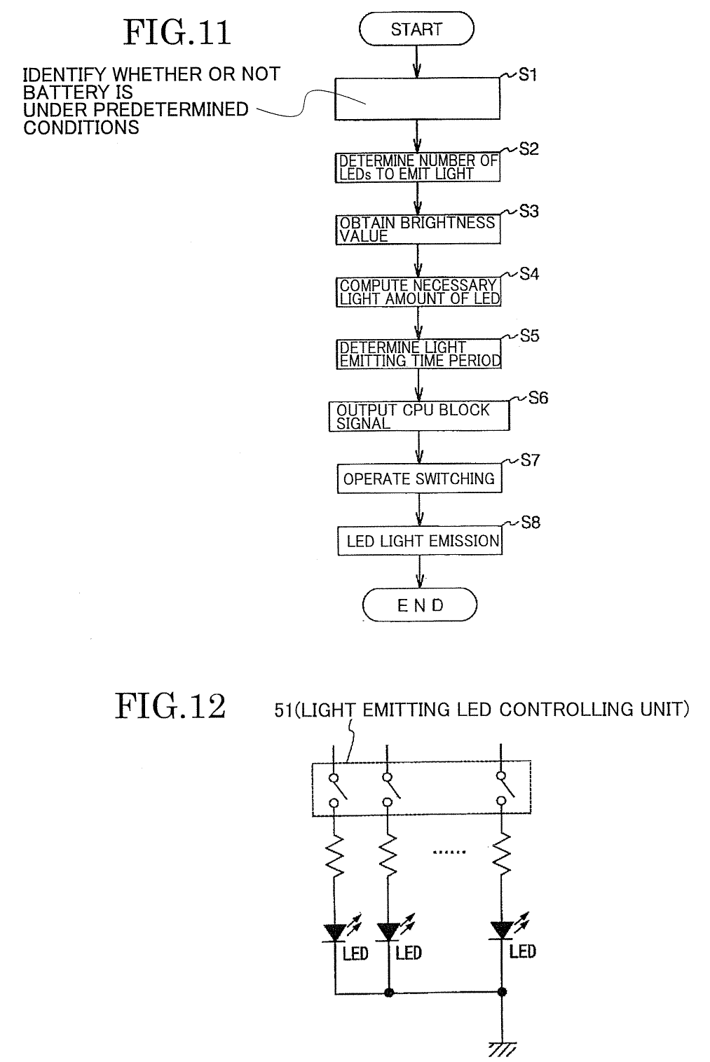

FIG. 11 is a flowchart in a case where LEDs in the LED strobe lighting unit 44 are caused to emit light while the number of light emitting LEDs is controlled under the predetermined conditions 1 to 4. Here, a second light emission sequence is explained in terms of parts different from the first light emission sequence while parts overlapping with the first light emission sequence are omitted.

In step S1 in which a check is made to determine whether or not the digital camera 1 is under any of the predetermined conditions 1 to 4, as shown in FIG. 7, each of the predetermined conditions 1 to 4 is weighted in proportion to the increasing amount of current consumption, and then the increasing amount of current consumption is estimated on the basis of the additional value of weights of currently-occurring conditions. Next, as shown in FIG. 8, the number of LEDs to emit light is defined according to the increasing amount of current consumption. In this case, the LED strobe light circuit 26 is provided with a light emitting LED controlling unit 51 shown in FIG. 12. This light emitting LED controlling unit 51 limits the number of LEDs to emit light. However, as the number of light emitting LEDs decreases, the total light emitting amount decreases. For this reason, the light amount decreasing due to the decrease of the number of light emitting LEDs is compensated by elongating a time period for the light emitting LEDs to emit light. In step S6, a signal is outputted from the CPU block 104-3 to the light emitting LED controlling unit 51 of the LED strobe light circuit 26, for example, in the circuit configuration shown in FIG. 12. In response to the signal thus outputted, the light emitting LED controlling unit 51 operates the switches (step S7). Thereby, the current is supplied to the LEDs of the number determined in step S3, and thereby the determined number of LEDs are caused to emit light (step S8).

The first and second light emission sequences are used individually or in combination with each other.

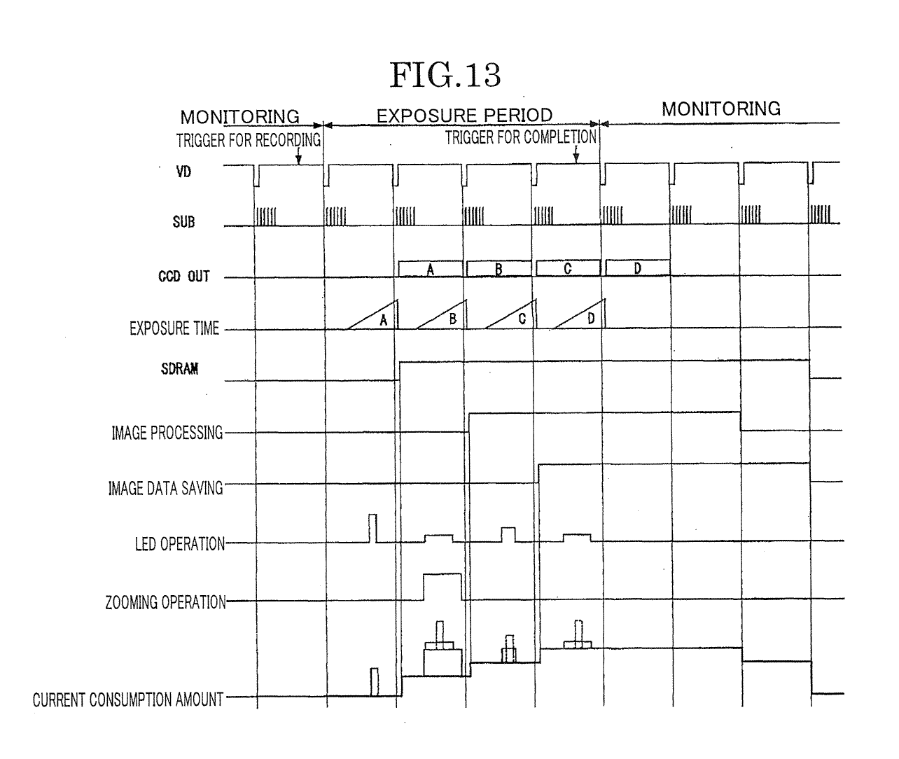

According to the foregoing methods, by causing each LED in the LED strobe lighting unit 44 to emit light while the amount of current flowing into each LED is limited under the predetermined conditions 1 to 4 for increasing the amount of current consumption, it is possible to reduce current consumption peaks (parts indicated by dotted lines) which have conventionally occurred in the LED strobe lighting unit 44 as shown in FIG. 13.

### Second Embodiment

Hereinafter, a second embodiment of the imaging apparatus of the present invention will be described.

In general, a primary battery such as an alkaline battery, a nickel-manganese battery and a lithium battery, and a secondary battery such as a nickel hydride battery and a lithium-ion battery have been heretofore used as batteries for a digital camera. The progress in developing batteries has increased the capacity of a battery year by year. Thereby, a longer battery life has been achieved. Meanwhile, the improvement of semiconductor technology leads to the development of an IC capable of operating with a lower voltage. With this IC, a battery can be used even after the battery starts supplying a lower voltage than a conventional battery, whereby a much longer battery life can be achieved. The functions of a digital camera in recent years have been diversified, so that the digital camera has not only a still image pickup function, but also a moving image recording function, a voice recording function and even a communication function. In many cases, modes specific to the respective functions are prepared. However, such preparation of the modes specific to the respective functions places such a limitation on operations that multiple operations cannot be carried out at the same time beyond each of the modes. For example, operations such as image pickup and voice recording may not be allowed to be carried out during an operation of transmitting an image. This results in poor usability of the digital camera. For this reason, it is desired to design a digital camera such that multiple operations can be carried out at the same time beyond each of the modes to enhance the usability. In this case, a communication environment is particularly required to be highly reliable. Accordingly, an apparatus in operation must not be stopped while making communications in order not to lose or damage an image.

In this regard, one of the objects of the second embodiment is to achieve highly-reliable communications in an imaging apparatus having a communication function such that the imaging apparatus can be prevented from being powered off while making communications.

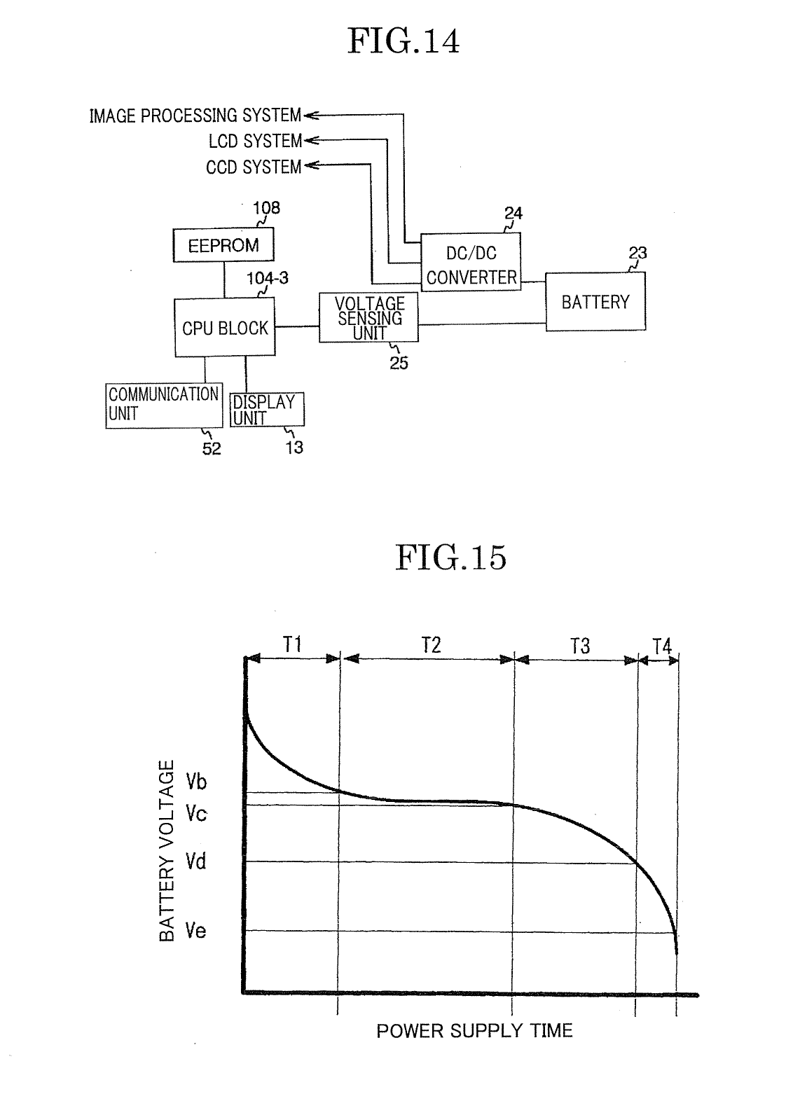

FIG. 14 is a diagram showing an essential configuration of a digital camera 1 according to the second embodiment of the present invention. In FIG. 14, the same reference numerals are given to the same components as those in FIGS. 2A to 2D.

The digital camera 1 according to the second embodiment includes: a battery 23 for supplying power; a DC/DC converter 24 for converting the battery voltage into voltages necessary for systems such as a CCD system, an LCD system and an image processing system; and a voltage sensing unit 25 for sensing the battery voltage to determine the remaining battery capacity. In addition, the digital camera 1 further includes: an EEPROM 108 for storing a control program and set values; a CPU 104-3 for comparing the battery voltage with a predetermined threshold value stored in the EEPROM 108; an LCD monitor (display unit) 13 for displaying images and the like; and a removable communication unit 52. Incidentally, as for the communication unit 52, it is possible to use a component incorporated inside the digital camera 1 or a removable card-type component used while being inserted in the external extended memory mounting portion (memory card throttle) 22 and the like.

In an apparatus using a battery, the battery voltage is usually monitored. The battery voltage gradually decreases with use of the apparatus. On the other hand, the operating of the apparatus requires a minimum necessary driving voltage of a predetermined value, and a system down occurs when the power supply voltage becomes lower than the minimum driving voltage. Such a system down causes problems of damaging data, breaking down an IC and the like. Accordingly, before the power supply voltage becomes lower than the minimum driving voltage, it is necessary to perform processing of informing a user that the remaining battery capacity is near its end, and to perform processing of normally terminating the apparatus in operation without damaging data or breaking down an IC. In general, a battery check table (referred to as a BC table, below) is used to display the remaining battery capacity and to normally terminate the apparatus while the remaining battery capacity is in the end status. The BC table is stored in the EEPROM 108. In the BC table, a voltage value is set as a reference for controlling the apparatus.

FIG. 15 is a diagram showing the discharge characteristic of the battery 23.

The vertical axis in FIG. 15 indicates a battery voltage and the horizontal axis indicates a power supply time, that is, a time period of using the apparatus. In addition, FIG. 15 shows the set values that are the voltage values set in the BC table as Vb, Vc, Vd and Ve. In the shown example, when the battery voltage becomes Ve, the system termination processing is performed.

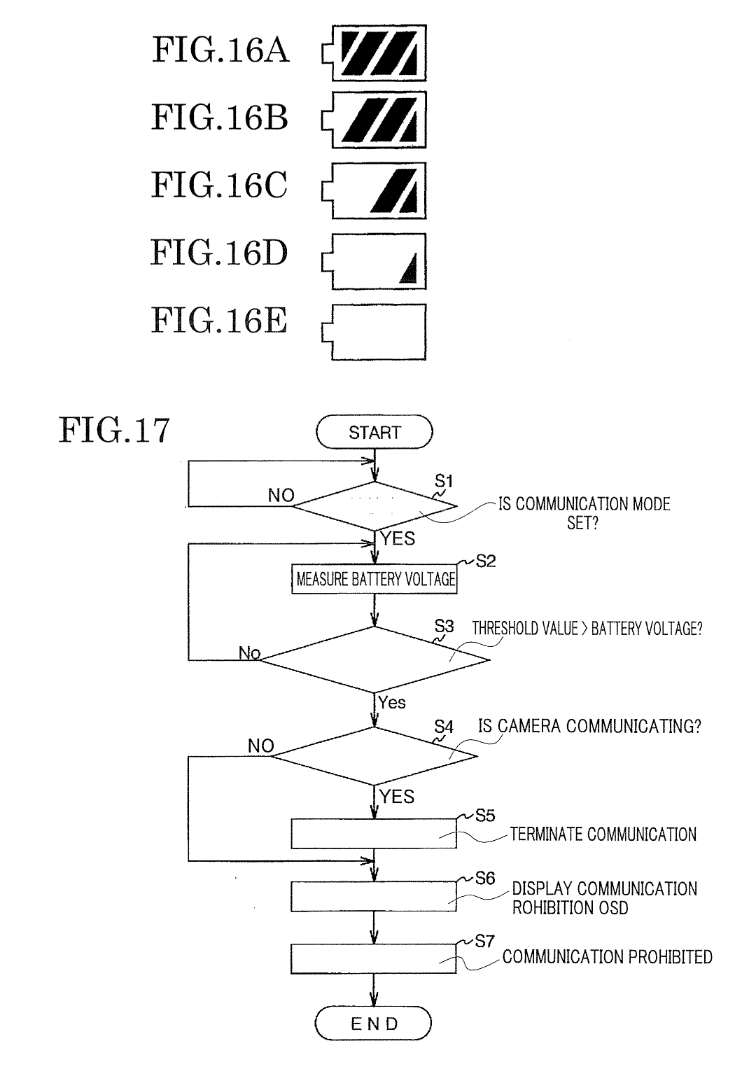

Moreover, as shown in FIG. 15, the time period of using the apparatus is divided into 4 time periods T1, T2, T3 and T4. Marks shown in FIGS. 16A to 16D are displayed in the time periods T1 to T4, respectively. Moreover, a mark shown in FIG. 16E is displayed immediately before the system termination processing. With this mark, the user is informed of the battery end. As such, the multiple reference voltage levels are set in the BC table. When the battery voltage becomes lower than one of the reference voltage levels, the remaining battery capacity display mark is changed to another one. Then, when the battery voltage reaches the reference voltage level corresponding to the battery end, the processing of terminating the system operation is performed.

In the conventional apparatus, when the battery voltage becomes lower than a predetermined threshold value, the processing of terminating the operations of the entire apparatus is performed. Meanwhile, in the second embodiment, a new threshold value related to communications is set in the BC table. When the battery voltage becomes lower than a predetermined threshold value, an image indicating an impossibility of communications is displayed on the LCD monitor 13, and the digital camera 1 is prohibited from performing the operation for communications.

By referring to a flowchart shown in FIG. 17, descriptions will be provided for an operation of the digital camera 1 according to the second embodiment.

Firstly, it is detected whether or not the digital camera 1 is currently set in a mode for making communications (referred to as a communication mode, below) (step S1). When it is detected that the digital camera 1 is set in a mode other than the communication mode, step S1 is repeated without moving the operation to the next step. When it is detected that the digital camera 1 is set in the communication mode, the battery voltage is detected and determined (step S2). Next, the value of the battery voltage is compared with the set threshold value (step S3). Here, it is possible to use the value of the battery voltage obtained by performing the AD conversion of the battery voltage with the CPU block 104-3. When the battery voltage is lower than the threshold value as a result of comparing the battery voltage value with the threshold value, it is checked whether or not the digital camera 1 is currently making communications (step S4). When the digital camera 1 is currently making communications, the communications are terminated at an appropriate timing (step S5). For example, when the digital camera 1 is transmitting or receiving a file, the communication is forcibly terminated upon completion of transmitting or receiving the file that is currently transmitted or received. After the communication is terminated, an image indicating the prohibition of communications is displayed in an OSD mode on the LCD monitor 13 (step S6), and the digital camera 1 is prohibited from making communications (step S7). On the other hand, when it is determined that the digital camera 1 is out of the communication status as a result of checking the communication status of the digital camera 1 in step S4, the image indicating the prohibition of communications is displayed in the OSD mode on the LCD monitor 13, and the digital camera 1 is prohibited from making communications (steps S6 and S7).

USB communications, a wireless LAN, Bluetooth or the like has been used as a communication environment of the digital camera 1. In recent years, a direct print system (DPS) has also been used. In this DPS, a printer prints out an image picked up by an imaging apparatus with the imaging apparatus and the printer directly connected to each other.

As described above, the battery-operated digital camera 1 described in the second embodiment is particularly effective while being operated with power supplied only from the battery 23 provided to the digital camera 1. For this reason, the digital camera 1 described in the second embodiment is suitable for a case where the digital camera 1 makes wireless communications without being physically supplied with power from the outside or where the digital camera 1 makes communications without receiving power supply via a connection cable even in a wired communication. Moreover, when the digital camera 1 receives the power supply from the outside, the digital camera 1 is capable of terminating the communications in response to a decrease of the power supply to the digital camera 1 caused by a fault on the power supply side (a PC or the like), thereby preventing a loss and damage of an image and the like.

Moreover, when the digital camera 1 of the second embodiment makes communications under the predetermined conditions, the digital camera 1 can reduce power consumption by operating only minimum components necessary for allowing the communication unit 52 to operate while stopping the operations of the other components that are unnecessary for allowing the communication unit 52 to operate. In this way, the digital camera 1 can reduce the power load. Accordingly, the digital camera 1 is prevented from being powered off while making communications, thereby achieving data communications at a high level of safety.

Here, by using FIGS. 2A to 2D, recited are the minimum components necessary for allowing the communication unit 52 to operate at this time: the system controller 104 for controlling the digital camera 1; the ROM 108 in which the control program is stored; the RAM 107 onto which the control program is expanded; the built-in memory 120 in which an image is stored or the memory card throttle (external extended memory mounting portion 22) reading data from a memory card; the SDRAM 103 necessary for expanding the image onto the memory; and the SUB-CPU 109 for playing a supporting role for the system controller 104. In a case where an LSI having various functions like the system controller 104 has a function of powering on and off each functional block, it suffices to stop the components other than the CPU block 104-3, the memory card controller block (external extended memory block) 104-10 and the Local-SDRAM 104-4 while the digital camera 1 is making communications. Incidentally, in order to make the current communication status more understandable, one of an operation of causing an LED to blink during communications and an operation of displaying the progress status of the communication on the sub-LCD 11 or the LCD monitor 13 can be selected according to the remaining battery capacity, and then be performed to the extent that the communication unit 52 would not be burdened.

When the digital camera 1 has a high remaining battery capacity, multiple operations can be carried out at the same time. More precisely, for example, a user can transmit an image while recording images, or can make communications while watching reproduced images.

However, if multiple operations are carried out at the same time while the remaining battery capacity is low, the battery may be disabled from supplying a required amount of power to the apparatus, thereby stopping the apparatus. For this reason, to cope with this case, a battery voltage is employed as one of the predetermined conditions for increasing the current consumption, and a predetermined threshold value is set for the battery voltage. Then, when the battery voltage becomes lower than the threshold value, the communications are made by operating the minimum components necessary for allowing the communication unit 52 to operate.

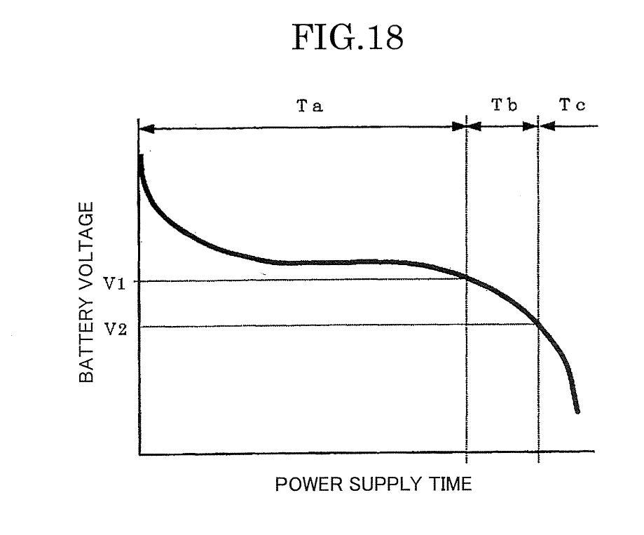

FIG. 18 is a graph showing a relationship between the battery voltage and the power supply time. As shown in FIG. 18, two threshold values V1 and V2 are set for the battery voltage. In a time period (Ta) in which the battery voltage is higher than the threshold value V1, the imaging apparatus can be operated without any limitation on the functions. In a time period (Tb), the battery voltage is lower than the threshold value V1 since the battery voltage becomes low with the operations of the imaging apparatus. In this time period (Tb), the imaging apparatus makes communications by operating only the minimum necessary components. In addition, in a time period in which the battery voltage is lower than the threshold value V2 since the battery voltage further becomes lower due to an increase of a time period of using the imaging apparatus, an image indicating an impossibility of communications is displayed on the LCD and the like, and the imaging apparatus is prohibited from making communications.

In addition, batteries having various functions are used for an imaging apparatus capable of using multiple types of batteries. In particular, in a case of using a battery having a low battery capacity like an alkaline battery, it is difficult to carry out multiple operations at the same time even with use of a new battery. Accordingly, battery capacity is employed as one of the predetermined conditions for increasing the current consumption, and the imaging apparatus is provided with a determination unit for determining a type of battery. Then, when the power source as a battery having a low capacity is determined by the determination unit, the digital camera 1 is configured to make communications through operation of the minimum components necessary to operate the communication unit 52. Note that, although not specifically described here, there are various conventionally-known methods of determining a type of battery, such as a method of making a determination based on a difference in shape among batteries and a method of making a determination based on a difference in voltage among power sources.

According to the second embodiment, a determination is made as to whether or not to make communications according to the remaining battery capacity, and the imaging apparatus is prohibited from making communications before the battery is dead, that is, the imaging apparatus runs out of the electric charge stored in the battery 23. In this way, a sudden stop of communications attributed to the death of a battery is prevented, thereby achieving highly reliable communications. Moreover, the operating components in the imaging apparatus are changed depending on the battery voltage or the type of battery so that a longer life of the battery 23 can be achieved. Consequently, the imaging apparatus can make communications for a longer time period.

### Third Embodiment

Hereinafter, a third embodiment of the present invention will be described. As a generally-used battery for a conventional digital camera, there have been primary batteries such as an alkaline battery, a nickel-manganese battery and a lithium battery and secondary batteries such as a nickel hydride battery and a lithium ion battery. The progress of developing a battery has increased the battery capacity, whereby battery life has been attempted to be made much longer. In addition, the improvement of the semiconductor technology has led to the development of an IC capable of operating with a low voltage. Since use of this IC allows a battery to be used even after the battery starts supplying a lower voltage than a conventional battery, a much longer battery life can be achieved. The alkaline battery of the primary battery and the nickel hydride battery of the secondary battery are identical to each other in shape, and are substantially equal to each other in the voltage range. Accordingly, it is not a rare case that a nickel hydride battery is charged and used for usual purposes while an alkaline battery is used only for an emergency. However, the nickel hydride battery has a characteristic called a memory effect. The memory effect is a characteristic that, when a battery is recharged without completely discharging electricity from the battery, the battery memorizes the charge level immediately before being recharged, and stops supplying electricity when the charge level reaches the memorized charge level, even though the battery still has electricity. In an apparatus, like a digital camera, operations of a motor system such as the zooming operation and focus operation accompanying with vigorous shifts in the voltage are performed. Consequently, such an apparatus is more likely to produce the memory effect on a battery since the electricity cannot be completely discharged from the battery so that the apparatus fails to make full use of the battery capacity.

To cope with this, for example, in a method disclosed in Japanese Utility Model Application Laid-open Publication No. Hei 5-153521, a timer circuit starts operating when the voltage of a battery in an apparatus in use reaches a shut-off voltage, and then the battery starts discharging electricity after a predetermined time period elapses from the time point when the voltage of the battery reaches the shut-off voltage. This method is convenient in that the battery automatically discharges electricity. However, in an environment in which various batteries are used as described above, a primary battery and the like, which do not need to discharge electricity, are also caused to automatically discharge electricity. In this regard, an object of the third embodiment is to provide a digital camera 1 enabling a user to easily discharge electricity from a battery.

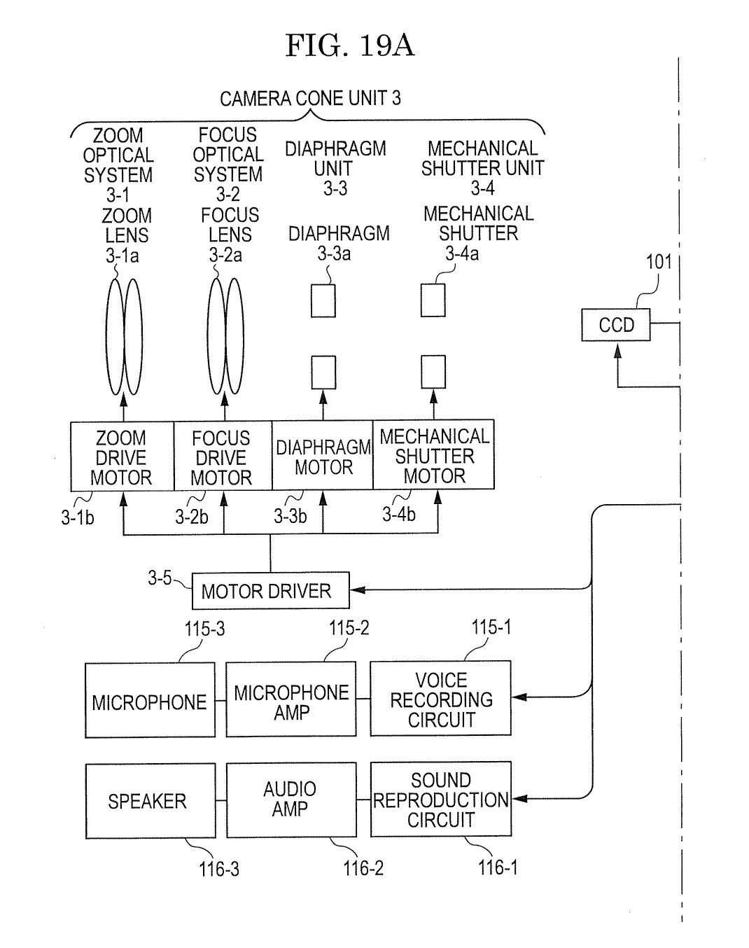

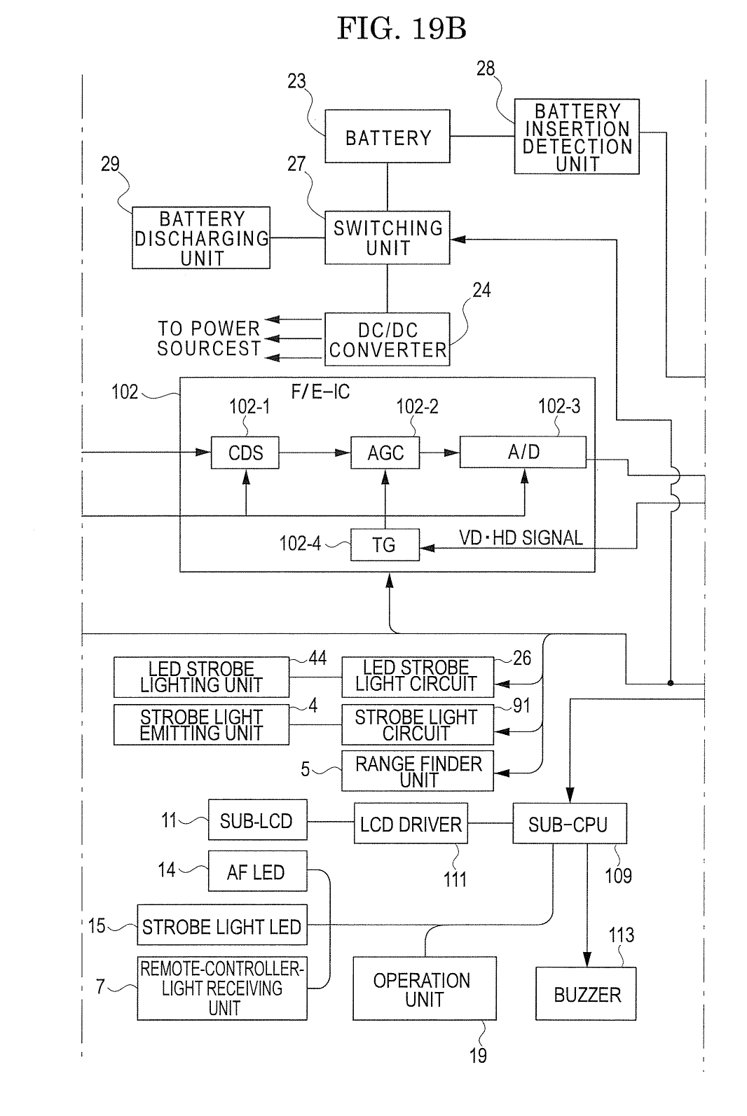

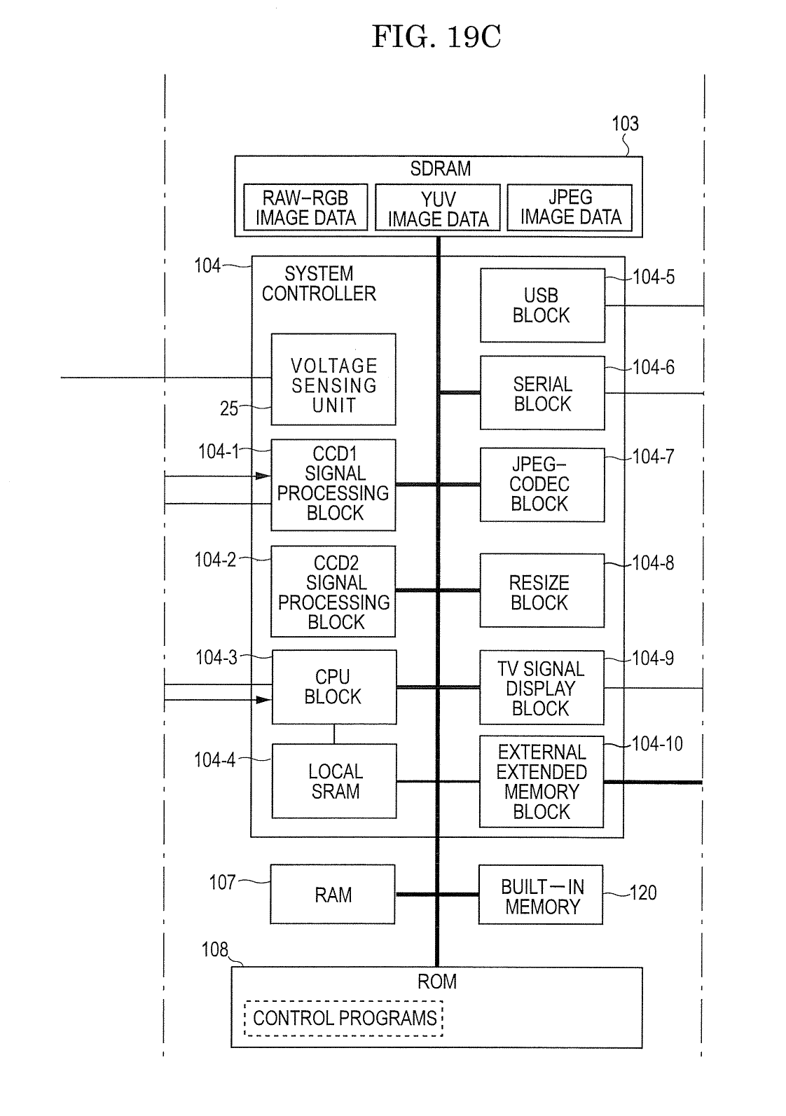

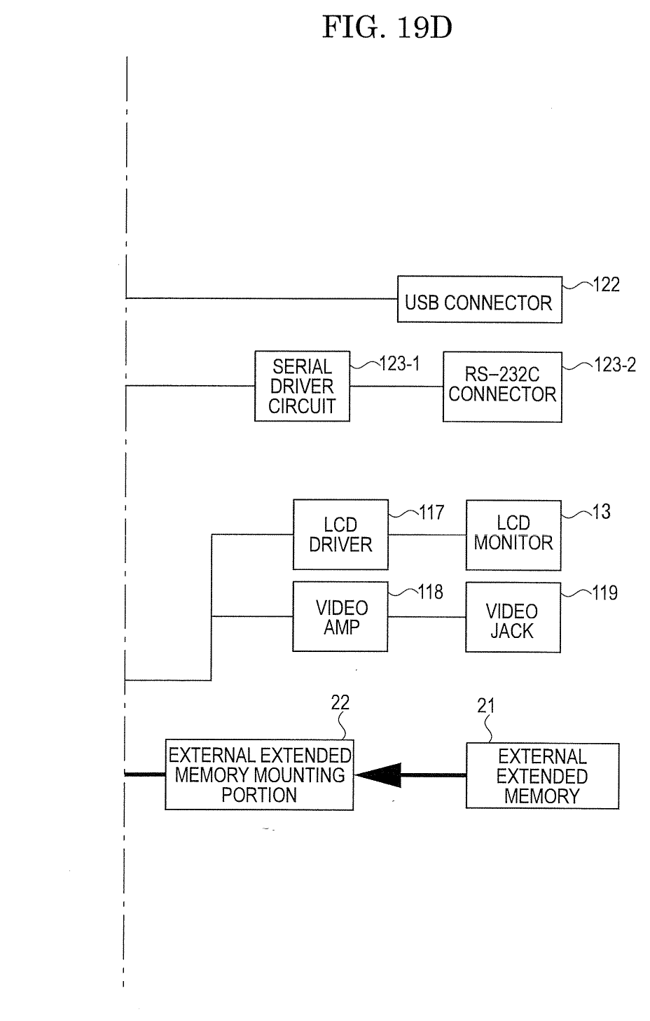

FIGS. 19A to 19D are a block diagram showing a schematic configuration of the digital camera 1 according to the third embodiment.

Note that, in FIGS. 19A to 19D, the same reference numerals are given to the same units as those in FIGS. 2A to 2D.

The digital camera 1 according to the third embodiment is one obtained by adding a switch unit 27, a battery insertion detection unit 28 and a battery discharging unit 29 to the digital camera 1 shown in FIGS. 2A to 2D.

Prior to the explanation of the digital camera 1 according to the third embodiment, the descriptions will be again provided below for a battery check system used for displaying the remaining capacity of the battery 23 and for normal termination of the apparatus, by referring to FIGS. 15 and 16A to 16E.

In general, an apparatus using a battery monitors the battery voltage. The battery voltage gradually decreases as the apparatus is used. On the other hand, the operating of the apparatus requires a minimum driving voltage of a predetermined value, and a system down occurs when the power supply voltage becomes lower than the minimum driving voltage. Such a system down causes problems of damaging data, breaking down an IC and the like. Accordingly, before the power supply voltage becomes lower than the minimum driving voltage, it is necessary to perform processing of informing a user that the remaining battery capacity is near its end and processing of normally terminating the operations of the apparatus without damaging data or breaking down an IC.

FIG. 15 is a diagram showing a discharging characteristic of the battery 23. In FIG. 15, the vertical axis indicates a battery voltage, and the horizontal axis indicates a power supply time (the time period of driving the apparatus). FIGS. 16A to 16E each show a remaining battery capacity display mark. In FIG. 15, threshold values (V1, V2, V3 and V4) are set for the battery voltage. Note that the threshold values V1 to V4 satisfy the relationship of V1>V2>V3>V4. Here, assuming that the battery voltage obtained by the A/D conversion in the voltage sensing unit 25 is Ve, FIG. 15 indicates as T1 a time period when Ve satisfies the relationship of Ve>V1, and indicates as T2 a time period when Ve satisfies the relationship of V2<Ve<V1. In addition, FIG. 15 indicates as T3 a time period when Ve satisfies the relationship of V3<Ve<V2, indicates as T4 a time period when Ve satisfies the relationship of V4<Ve<V3, and indicates as T5 a time period when Ve satisfies the relationship of Ve<V4. According to the result of comparing the battery voltage Ve with the threshold values (V1 to V4) by the CPU block 104-3, a mark indicating that the battery 23 has a full remaining capacity is displayed on the LCD 13 or the sub-LCD 11 in the time period T1 (Ve>V1) as shown in FIG. 16A. In the time period T2 (V2<Ve<V1), as shown in FIG. 16B, a mark indicating that the remaining capacity of the battery 23 has decreased a little bit is displayed on the LCD 13 or the sub-LCD 11. In the time period T3 (V3<Ve<V2), as shown in FIG. 16C, a mark indicating that the remaining capacity of the battery 23 has decreased to a greater extent is displayed on the LCD 13 or the sub-LCD 11. In the time period T4 (V4<Ve<V3), as shown in FIG. 16D, a mark indicating that the remaining capacity of the battery 23 is small is displayed on the LCD 13 or the sub-LCD 11. In the time period T5 (Ve<V4), as shown in FIG. 16E, a mark indicating that the battery 23 has no remaining capacity is displayed on the LCD 13 or the sub-LCD 11. With this display, a user is informed that the battery 23 is in the end state. In addition, when the battery 23 becomes in the end state, the system termination processing is performed in order to normally terminate the apparatus. What is generally termed as a battery check (abbreviated as BC, below) system is a system having threshold values set as references as described above and functioning in the following manner. When the battery voltage is lower than any one of the reference threshold values as a result of comparing the battery voltage with the threshold values, the system changes the remaining battery capacity display mark to another one. Moreover, when the remaining battery capacity reaches the battery end, the processing of terminating the system operation is performed.

Hereinafter, the digital camera 1 of the third embodiment will be described.

[Discharging Condition 1: Battery End Time]

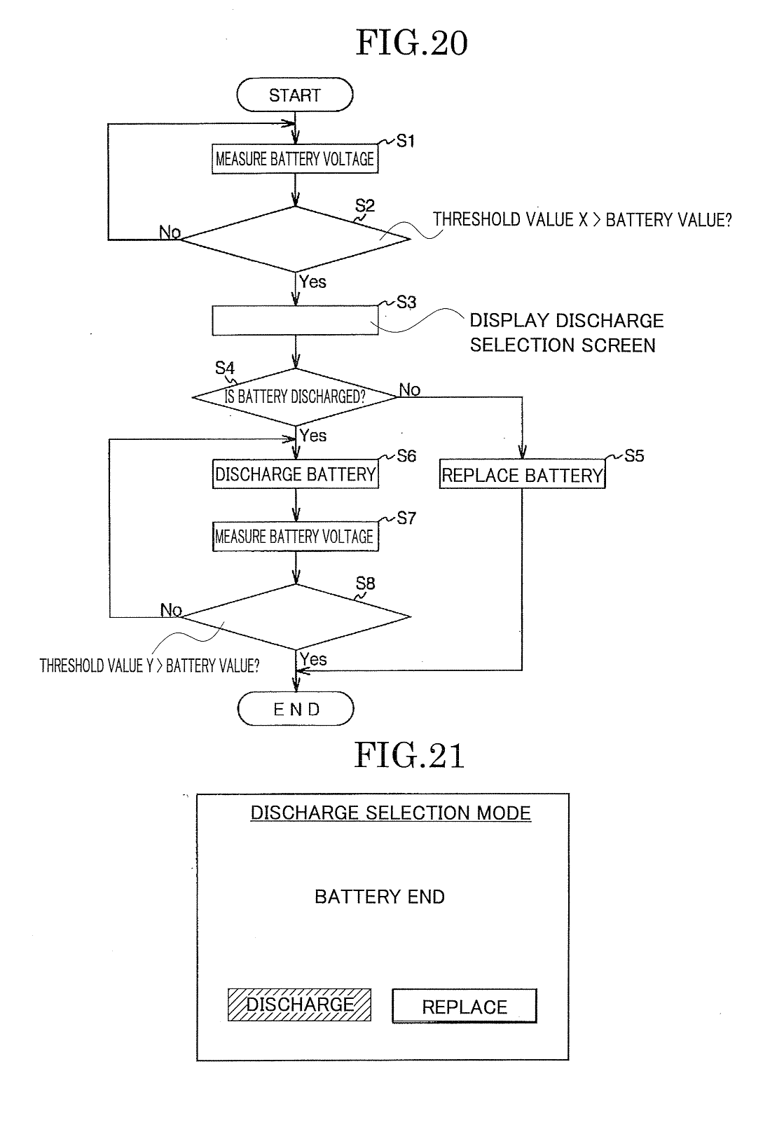

The digital camera 1 of the third embodiment can also employ a threshold value as a BC set value indicating battery end. Thereby, a threshold can be newly set as a reference for battery discharging. A first example using a threshold will be described below by referring to a flowchart shown in FIG. 20, and FIGS. 1 and 19. As shown in FIG. 20, battery voltage information is generated when the voltage sensing unit 25 performs the A/D conversion of the battery voltage (step S1). The CPU block 104-3 compares the battery voltage with a predetermined threshold value x stored in the ROM 108 (step S2). When the CPU block 104-3 determines the battery voltage to be larger than the threshold value x, the processing moves back to step S1. In contrast, when the CPU block 104-3 determines the battery voltage to be smaller than the threshold value x, a prompt asking a user to select whether to discharge or to replace the battery 23 is displayed on the LCD 13 or the sub-LCD 11 (step S3).

The user selects whether to discharge or to replace the battery 23 by operating the operation unit 19 in response to the prompt (step S4). After the user selects whether or not to discharge the battery by operating the operation unit 19, the CPU block 104-3 outputs a signal to the switch unit 27 (see to FIG. 19A TO 2D) in accordance with the selection. The switch unit 27 has a function of switching the output destination of the battery 23 between the discharging unit 29 (see FIGS. 19A to 19D) and the DC/DC converter 24 in accordance with the signal from the CPU block 104-3. When the user selects to replace the battery in step S4, the battery 23 is replaced (step S5). When the user selects to discharge the battery in step S4, the battery is discharged in the following discharging manner (step S6).

[First Discharging Method]

A first discharging method is one using a resistance constituting a battery discharging unit 29. When the battery discharging unit 29 is composed of the resistance, the battery power is converted into thermal energy by the resistance, and thus is discharged. When the battery is discharged by use of the battery discharging unit 29, the switch unit 27 switches the battery output destination from the DC/DC converter to the battery discharging unit 29 in response to a signal from the CPU block 104-3. As for the resistance of the battery discharging unit 29, it is possible to employ not only one type of resistance, but also multiple types of resistances having different resistance values, that is, higher and lower resistance values. A resistance having a low resistance value allows a large amount of current to flow, and thereby the discharge can be completed in a shorter time. In contrast, a resistance having a high resistance value allows a small amount of current to flow, and thereby the discharge requires a longer time. Accordingly, when the battery is discharged at a high speed, the resistance having the low resistance value is selected among the multiple types of resistances. On the other hands, when the battery is discharged at a low speed, the resistance having the high resistance value is selected among the multiple types of resistances.

Moreover, the discharge speed can be changed by using the multiple resistances in combination in a single discharge. For example, in an initial period of the discharge, the battery is discharged at a high speed by using the resistance having the low resistance value until the voltage value of the battery 23 reaches a predetermined voltage value. Then, after the voltage value of the battery 23 exceeds the predetermined voltage value, the battery is discharged at a low speed by using the resistance having the high resistance value. In this way, the battery discharge can be completed in a short time without causing overdischarge of the battery.

[Second Discharging Method]

A second discharging method is a method of charging a capacitor of a strobe light or the like, and a backup battery. In general, a digital camera is provided with a capacitor having a large capacity in a strobe light circuit 91, and the capacitor is used to emit strobe light. In addition, in the digital camera, an unillustrated backup battery (abbreviated as a BU battery, below) is used to hold settings for the camera and to operate a clock. For such a BU battery, a rechargeable battery or a capacitor instead of a battery is used in some cases. Accordingly, the battery can be discharged by charging the capacitor for the strobe light and the capacitor for the BU battery. As a result, as compared with the discharge with the resistances employed in the first discharging method, the current discharged at a discharge time is effectively used, so that the energy is saved efficiently.

The battery discharge with the second discharging method depends on a method of supplying power to the strobe light circuit 91 and the BU battery. In a case of using a circuit configuration in which the capacitors for the strobe light and the BU battery are charged at a fixed voltage outputted from the DC/DC converter 24, the switch unit 27 switches the battery output destination to the DC/DC converter 24 in response to a control signal from the CPU block 104-3. In a case of employing a circuit configuration in which the battery voltage is directly applied to the capacitors for the strobe light and the BU battery, the switch unit 27 switches the battery output destination directly to these capacitors.

When the switch unit 27 selects the capacitors for the strobe light and the BU battery as battery output destinations, that is, discharging units, the capacitor for the strobe light is firstly charged, for example, in response to a strobe light charge signal from the CPU block 104-3. Upon completion of charging the capacitor for the strobe light, a BU battery charge signal is outputted from the CPU block 104-3, and thereby the BU battery is charged. It is preferable to switch the discharging units in the aforementioned order.

[Third Discharging Method]

A third discharging method is one causing a light-emitting device such as an LED to emit light.

The digital camera is provided with a backlight LED on the back face of the LCD panel for illuminating the LCD 13. In addition, there is a known digital camera provided with an AF-LED 14 for indicating an AF status at a time of image taking, and a strobe light LED 15 for indicating a strobe light charging status for the purpose of informing a user of the status of the camera.

In addition, in recent years, an LED strobe light using superluminescent LEDs of three colors R (Red), G (Green) and B (Blue) has already begun to emerge.

The battery is discharged by outputting a lighting signal or blinking signal from the CPU block 104-3 to such LEDs. In particular, there is a case where an LED strobe light has multiple LEDs of each of three colors, and further has a circuit configuration capable of changing the amount of current to be supplied to flow into each LED for the purpose of adjusting the light amount of the strobe light. In this case, as similar to the first discharging method, the high-speed discharge and the low-speed discharge can be freely performed by using multiple LEDs or by adjusting the amount of current to be supplied to each LED. In addition, various kinds of colors can be created by combining the three colors of LEDs, so that the light of the LEDs can provide a delight to the eyes of a user and a subject during the discharge of the battery.

The three discharging methods are used individually or in combination as described above.

As shown in FIG. 20, the voltage sensing unit 25 continuously detects the battery voltage during the discharge of the battery 23 (step S7). The CPU block 104-3 compares the battery voltage with a predetermined threshold value Y stored in the ROM 108 (step S8). The discharge is terminated when the CPU block 104-3 determines that the battery voltage reaches the predetermined voltage value. After the discharge is terminated, the discharge signal, the charge signal, the lighting signal and the blinking signal from the CPU block 104-3 are in an off state, and the control signal is outputted to the switch unit 27. In response to the control signal, the switch unit 27 switches the battery output destination to the DC/DC converter 24. In addition, in order for a user to judge the discharge status, during the discharge or at the end of the discharge, the progress condition of the discharge can be displayed on the sub-LCD 11, or the AF-LED 14 or the strobe light LED 15 can be lit up or blinked.

[Discharging Condition 2: Battery Inserting Time]

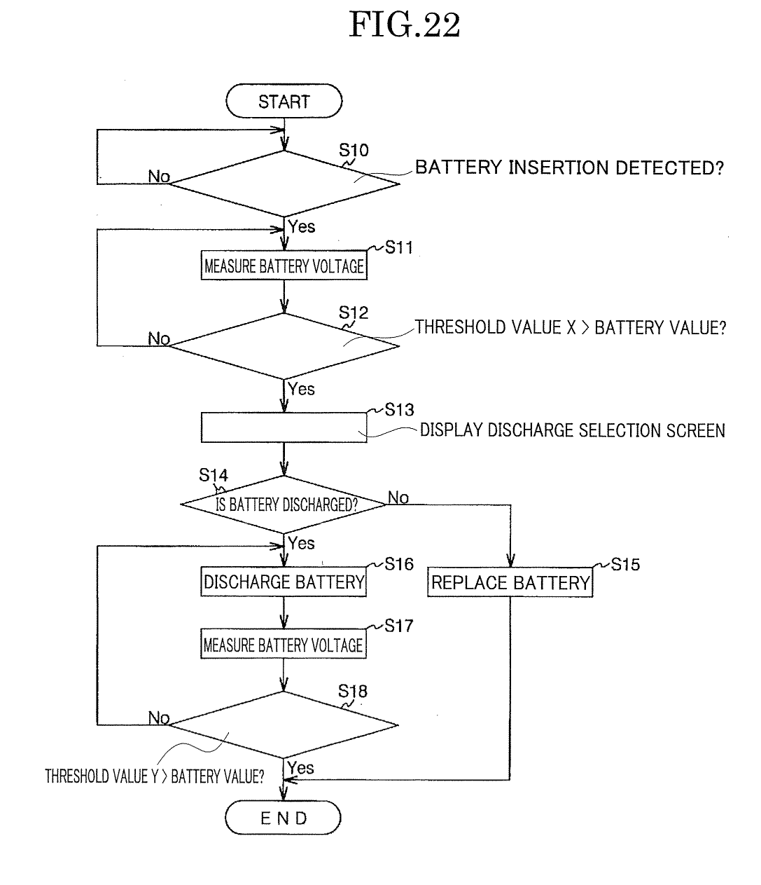

Another configuration example of the digital camera 1 of the third embodiment will be described by referring to a flowchart shown in FIG. 22 and FIGS. 1 and 19.

Upon insertion of a battery into an unillustrated battery mounting portion, the battery insertion detection unit 28 detects the insertion of the battery, and outputs a signal to the CPU block 104-3. Upon insertion of the battery 23 into the battery mounting portion, the battery insertion detection unit 28 detects the insertion of the battery 23, and the voltage sensing unit 25 measures the battery voltage (step S11). Here, since the battery insertion detection unit 28 only has to detect a voltage applied to a battery terminal, the voltage sensing unit 25 can be used to serve this function. The CPU block 104-3 compares the battery voltage with a predetermined threshold value stored in the ROM 108 (step S12).

However, the battery 23 tends to recover the voltage when a certain time passes after the battery 23 starts to be used. For this reason, the battery voltage immediately after the battery 23 is inserted is sometimes higher than the value at a time when the battery 23 is actually used. In this case, whether or not to discharge the battery cannot be accurately determined upon insertion of the battery. Accordingly, the battery voltage is measured under a condition in which a moderate amount of load is applied to the battery (step S1). In step S12, when the CPU block 104-3 determines that the battery voltage is larger than the threshold value, the processing gets out of the sequence. In contrast, when the CPU block 104-3 determines that the battery voltage is smaller than the threshold value in step S12, the processing moves to a step for selecting whether or not to discharge the battery (step S13). Incidentally, in the example shown in FIG. 21, the selecting operation to select whether to discharge or replace the battery 23 (steps S13 and S14) and the discharging operation (steps S16 to S18) are the same as those of steps S3 and S4, and steps S6 to S8, respectively, in the flowchart shown in FIG. 20. Accordingly, the explanation for these steps is omitted here.

As described above, by detecting and measuring the battery voltage at the time of inserting the battery 23, whether or not to discharge the battery can be determined without the digital camera powered on.

According to the third embodiment, when the CPU block 104-3 determines that the battery voltage reaches the predetermined threshold value, the digital camera causes a user to select whether or not to discharge the battery 23, and thus the user can easily discharge the battery 23. In addition, upon insertion of the battery, the battery voltage is detected and measured. Then, when the battery voltage thud detected is lower than the predetermined threshold, the user is caused to select whether or not to discharge the battery. Accordingly, the user can make a selection for battery discharge without powering on the digital camera. In this way, the imaging apparatus can be used while the battery 23 is prevented form producing a memory effect.

### Fourth Embodiment

Hereinafter, a fourth embodiment of the present invention will be described.

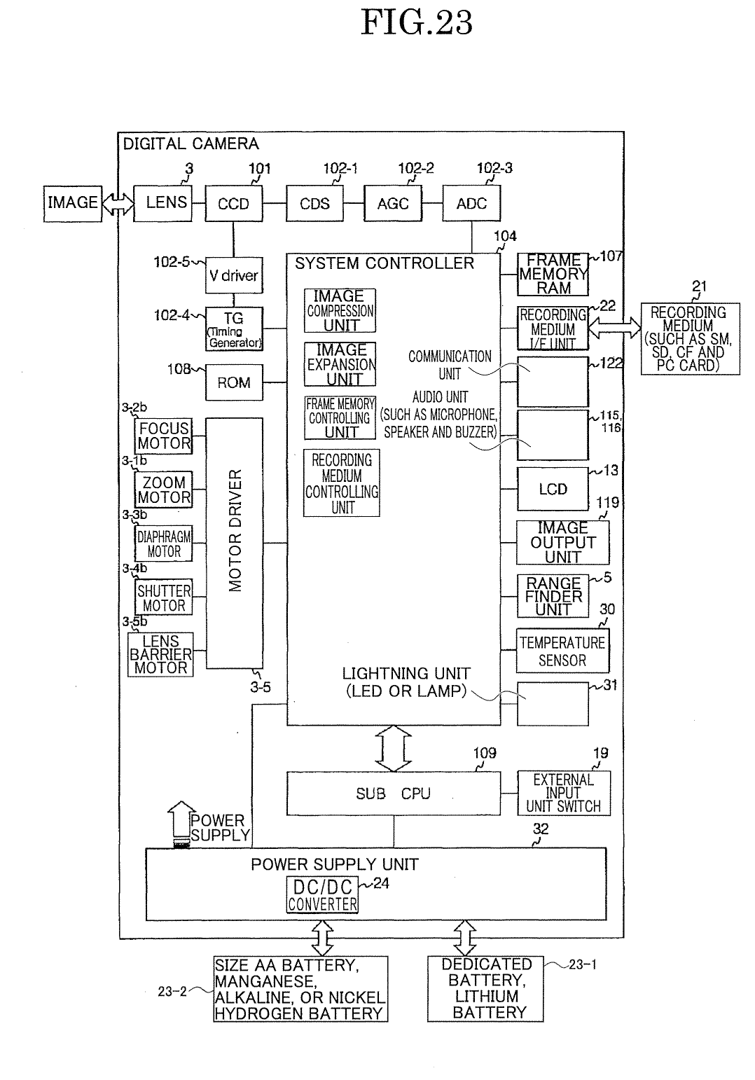

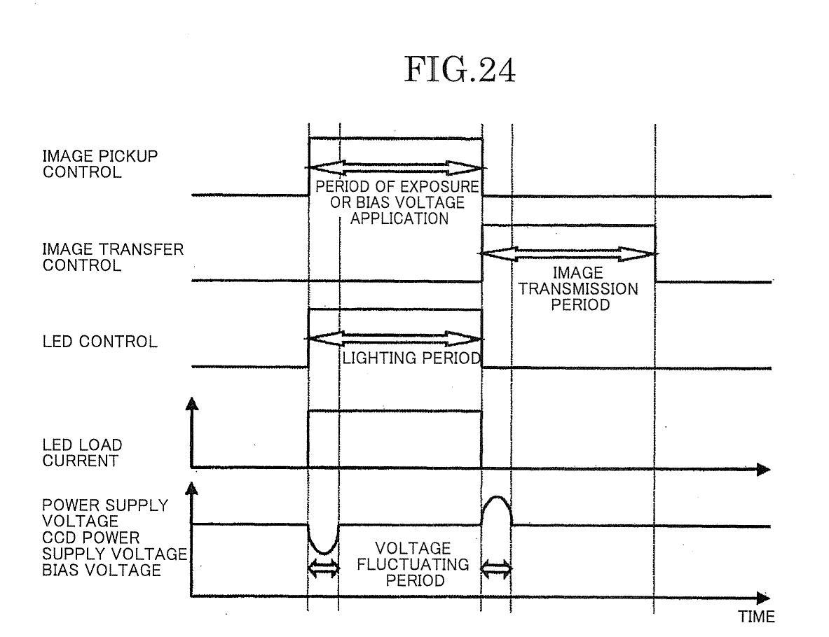

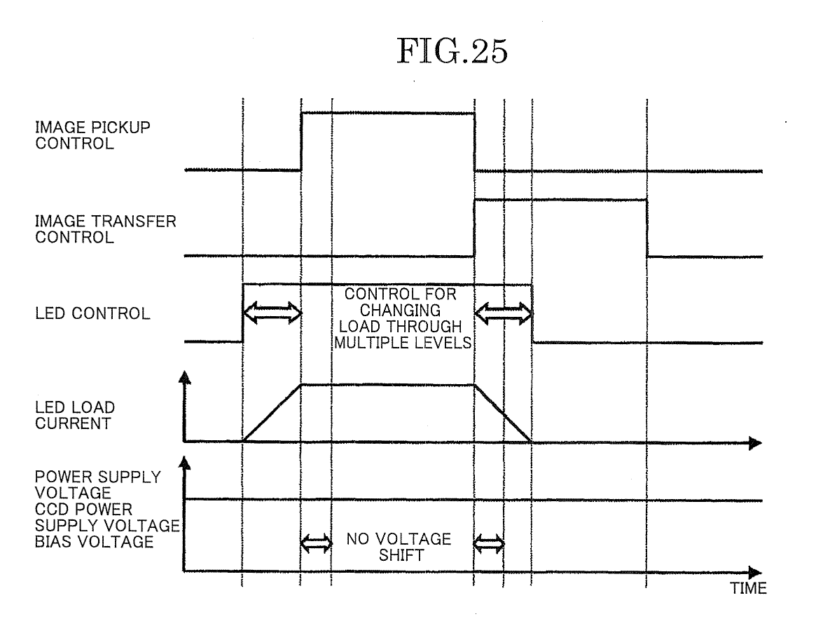

FIG. 23 is a block diagram showing a digital camera 1 of the fourth embodiment. FIGS. 24 and 25 are diagrams each showing a timing chart of each unit. In FIG. 23, the same reference numerals are given to the same units as those in FIGS. 2A to 2D, and the detailed description thereof is omitted here.

In the digital camera 1 shown in FIG. 23, a lighting unit (a semiconductor light-emitting device or a lamp) 31 and a CCD 101 are supplied with power from a common power source.

As shown in the timing chart in FIG. 24, the voltage and the bias voltage applied to the CCD 101 shift during a period when the CCD 101 records images (is exposed), or when the bias voltage is applied to the CCD 101. Such shifting causes a change in the analog value of data, and the image data is accordingly deteriorated.

When images of a subject are recorded with the lighting unit 31 lighting the subject, the lighting is carried out during an exposure period of the CCD 101 or a certain time period in the exposure period. However, since the load power applied to the lighting unit 31 for lighting is large, the voltage of the power source commonly used with the CCD 101 shifts if the lighting is carried out during the exposure period of the CCD 101 or the certain time period in the exposure period. If the voltage of the power source shifts, the voltage supplied to the CCD 101 also shifts, and this leads to a deterioration of image quality. In this regard, in the digital camera 1 according to this embodiment, the power supply to the lighting unit 31 is controlled so that a voltage fluctuation would not occur due to a large load for the lighting unit 31, or the power supply to the lighting unit 31 is controlled so that a voltage shift period would not overlap with an exposure period or a period when the bias voltage is applied. With this power supply control, unaging with lighting can be carried out without deteriorating the image quality.

In addition, in the digital camera 1 of this embodiment as shown in FIG. 25, the load power on the lighting unit 31 is shifted through multiple levels, and the power supply voltage or the voltage and bias voltage of the CCD 101 are controlled so as not to fluctuate. In this way, a change of the load on the lighting unit 31 is reduced, whereby imaging with lighting can be carried out without deteriorating the image quality.

In the digital camera 1 of this embodiment, the system controller 104 or the sub-CPU 109 recognizes the remaining power supply capacity. When the remaining power supply capacity is high, the power source has such a high power supply ability that the voltage shifts only to a small extent even when a large load is applied to the lighting unit 31. In contrast, when the remaining power supply capacity is low, the power source has such a low power supply ability that the voltage shifts to a large extent when a large load is applied to the lighting unit 31

As described above, the voltage shift amount varies in size depending on the remaining power supply capacity. For this reason, a long control time is set for supplying power to the lighting unit 31 when the remaining capacity is high, while a short control time is set when the remaining capacity is low, for example. Additionally, the different types of power sources have power supply capacities different from each other. For example, the lithium battery 23-1 and the like each have a high power supply ability, while an alkaline battery and a manganese battery 23-2 each have a low power supply ability. For this reason, as similar to the case where the remaining battery capacity differs, a short control time is set in the case of using a battery having a high power supply ability like the lithium battery 23-1, while a long control time is set in the case of using a battery having a low power supply ability like the alkaline battery and the manganese battery 23-2. By reducing the change of the load on the lighting unit 31 in this way, imaging with lighting can be carried out without deteriorating the image quality. In addition, by turning the lighting unit on and off within the minimum period, a release time lag can be minimized.

Moreover, in the digital camera 1 of this embodiment, the system controller 104 or the sub-CPU 109 perceives temperature data obtained by a temperature sensor unit 30.

A load current applied to the lighting unit 31 composed of a light-emitting diode, which is a semiconductor light-emitting device, a lamp or the like is shifted according to the temperature. A larger load current makes the voltage shift larger, while a smaller load current makes the voltage shift smaller.

Since the voltage shift amount varies according to the temperature as described above, a shorter control time is set when the temperature is higher, while a longer control time is set when the temperature is lower.

In addition, the power supply ability of the power source also changes according to the temperature. Specifically, the power supply ability is higher at a higher temperature, while the power supply ability is lower at a lower temperature. For this reason, as similar to the above description, a shorter control time is set when the power supply ability of the power source is higher, while a longer control time is set when the power supply ability of the power source is lower.

By reducing a change of the load on the lighting unit 31 in this way, imaging with lighting can be carried out without deteriorating the image quality. In addition, by turning the lighting unit 31 on and off within the minimum period, a release time lag can be minimized.

Further, in the digital camera 1 of this embodiment, in addition to the CCD 101, the light-emitting diode and the lamp, other various loads are supplied with power from the common power supply unit 32. When the total load including these loads is heavy, the power supply ability of the power source is low, so that the voltage shift is large. On the other hand, when the total load is light, the power supply ability of the power source is high, so that the voltage shift is small.

Since the voltage shift amount varies according to the load conditions as described above, a longer control time is set for heavier load, while a shorter control time is set for lighter load, for example.

By reducing a change of the load on the lighting unit 31 in this way, imaging with lighting can be carried out without deteriorating the image quality. In addition, by turning the lighting unit 31 on and off within the minimum period, a release time lag can be minimized.

In the digital camera 1 of this embodiment, the controlling method of changing the control time according to the load is stored in advance in the ROM 108 or the like, the controlling unit performs predetermined controls by reading the control method stored in the ROM 108.

Reducing a change of the load in this way allows imaging with light to be carried out without deteriorating the image quality, and also the controls to be performed easily.

In the digital camera 1 of this embodiment, the system controller 104 monitors changes in the load (voltage shift or current change) on the lighting unit 31. Then, the main controller 104 decreases the load current when the voltage shift is large, and increases the load current when the voltage shift is small. In this way, a change of the load on the lighting unit 31 can be accurately and surely reduced, so that imaging with lighting can be achieved without deteriorating the image quality.

In the digital camera 1 of this embodiment, the system controller 104 also monitors the load change (voltage shift or current change) of the power supply unit 32. Then, the system controller 104 decreases the load current when the voltage shift is large, and increases the load current when the voltage shift is small.

In this way, a change of the load on the lighting unit 31 can be accurately and surely reduced, so that imaging with lighting can be achieved without deteriorating the image quality.

In the digital camera 1 of this embodiment, as shown in FIGS. 24 and 25, the power supply to the light unit 31 is controlled so as not to start or stop while the CCD 101 is recording images (are exposed) or while the bias voltage is being applied to the CCD 101. Alternatively, a period when the CCD 101 is recording images (are exposed) or when the bias voltage is being applied to the CCD 101 is controlled so as not to overlap with a period when a voltage shift occurs due to a start or stop of the power supply to the lighting unit 31.

In addition, in the digital camera 1 of this embodiment, as shown in FIGS. 24 and 25, the power supply to the lighting unit 31 is controlled so as not to start or stop while the CCD 101 is transferring an image signal. Alternatively, a period when the CCD 101 is transferring an image signal is controlled so as not to overlap with a period when a voltage shift occurs due to a start or stop of the power supply to the lighting unit 31. According to the example shown in FIG. 24, imaging with lighting can be carried out without deteriorating the image quality through easy and reliable control. Moreover, according to the example shown in FIG. 25, wasteful consumption of power is prevented, thereby achieving power saving.

### Fifth Embodiment

Hereinafter, a fifth embodiment of the present invention will be described.

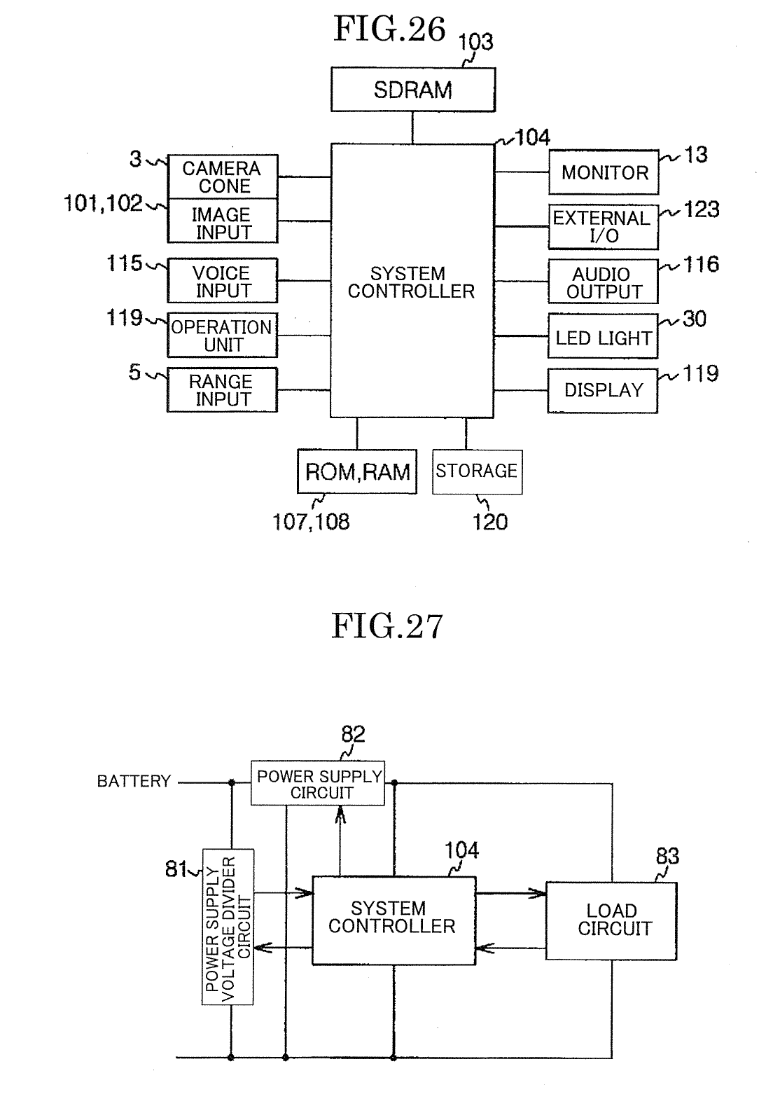

FIG. 26 is a block diagram showing a main configuration of a digital camera 1 of the fifth embodiment.

A camera cone unit 3 includes motor drivers each of which drives a motor for moving a corresponding one of lenses (a zoom lens and a focus lens), a diaphragm and a mechanical shutter. The lenses are provided to capture an optical image of a subject into a CCD 101. The driving of the camera cone unit 3 is controlled in accordance with a drive instruction from a system controller 104.

In a ROM 108, a control program and parameters for control are stored. Both the control program and parameters are written in codes that can be decoded by the system controller 104. When the digital camera 1 is powered on, the control program is loaded to an unillustrated main memory. The system controller 104 controls operations of each component of the digital camera 1 in accordance with the control program, and temporarily stores data and the like necessary for control in a RAM 107 and an SRAM 108. When a rewritable flash ROM is used as the ROM 108, the control program and parameters for control can be changed, so that the functions can be easily updated for version-up.

The CCD 101 is a solid state imaging device for performing a photoelectric conversion of an optical image, and an image processing section includes a circuit for correlated double sampling to remove image noise, a circuit for gain adjustment, and a circuit for digital signal conversion.

The system controller 104 includes two control blocks, one of which performs filtering processing on output data from the CCD 101 to the image processing section by making white balance and gamma settings, thereby converting the output data into brightness data and chroma data, and the other of which controls each of the aforementioned components of the digital camera 1. Moreover, the system controller 104 further includes: an SRAM for temporarily storing data and the like necessary for the control; a USB block for communicating with an external apparatus such as a personal computer through USB; a serial block for making serial communications with an external apparatus such as a personal computer; and a block for performing JPEG compression and expansion. Moreover, the system controller 104 includes: a block for enlarging and reducing the size of image data by performing interpolation; a TV signal display block for converting the image data into video signals for displaying the image data on an external display apparatus such as a liquid crystal monitor and a TV set; and a memory card block for controlling a memory card in which picked-up image data are recorded.

An SDRAM 103 temporarily stores image data when the system controller 104 performs each kind of processing on the image data. Examples of image data stored in the SDRAM 103 are: RAW-RGB image data which is captured to the aforementioned control block from the CCD 101 via the image processing section and which has the white balance and gamma set; YUV image data obtained by converting the image data into the brightness data and the chroma data; JPEG image data obtained by performing the JPEG compression on the image data; and the like.

A memory 120 is a built-in memory for storing picked-up image data even in a case where a memory card is not mounted in a memory card throttle.

A monitor 13 is a monitor for observing a state of a subject before an image thereof is picked up, for checking picked-up images and for displaying image data recorded in a memory card or the built-in memory.

An external I/O 123 is a circuit for converting the voltage of an output signal from the serial block in order to make serial communications with an external apparatus such as a personal computer.

An operation unit 119 is a key circuit to be operated by a user.

A voice recording unit 115 includes a microphone for receiving input of voice signals from a user, a microphone AMP for amplifying the inputted voice signals, and a voice recording circuit for recording the amplified voice signals.

The sound reproduction unit 116 includes: a sound reproduction circuit for converting the recorded voice signals into signals that can be outputted from a speaker; an audio AMP for driving the speaker; and the speaker for outputting the voice signals.

FIG. 27 is a diagram showing an example of a battery-voltage reading circuit.

In the battery-voltage reading circuit shown in FIG. 27, a power supply voltage divider circuit 81 divides the voltage of the battery, and the system controller 104 reads the voltage value of the battery by capturing the divided voltage and then by performing the A/D conversion of the divided voltage.

Incidentally, a power supply circuit 82 supplies power to each component of the digital camera 1. A load circuit 83 is connected to the power supply voltage divider circuit 81, the power supply circuit 82 and the system controller 104.

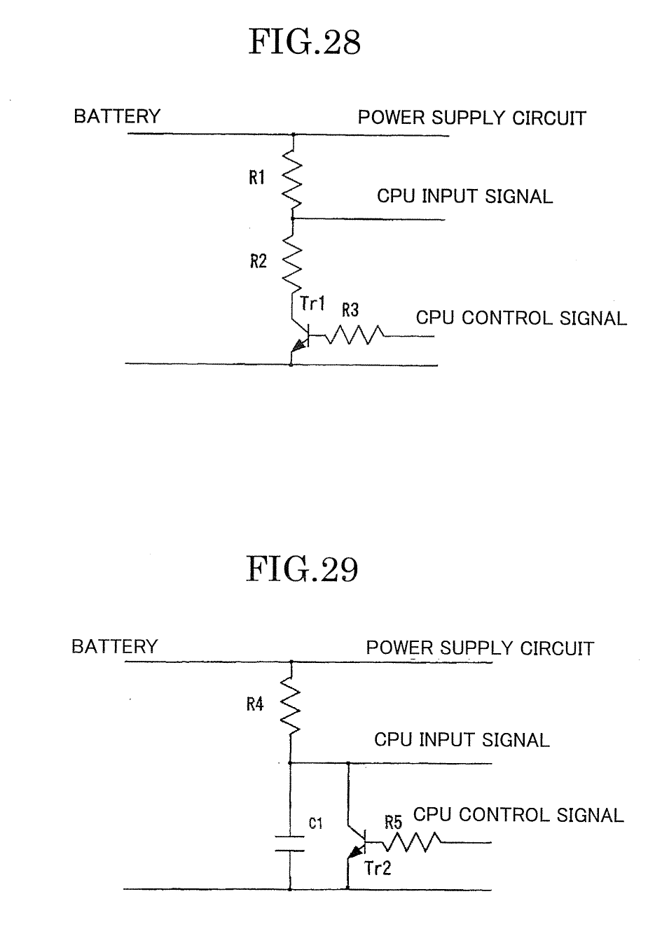

FIG. 28 is a diagram showing an example of a circuit configuration of the power supply voltage divider circuit 81. In the power supply voltage divider circuit 81, a CPU control signal from the system controller 104 is in a high-level state (called an “H state,” below), and a transistor Tr1 is turned on by the CPU control signal sent through a resistance R3. When the transistor Tr1 is turned on, the battery voltage is divided by resistances R1 and R2, and the battery voltage Vb/(R2/(R1+R2)) is applied to the system controller 104. The system controller 104 reads data obtained by the A/D conversion of the applied voltage, and converts the read data into the power supply voltage according to the voltage dividing ratio between R1 and R2. The transistor Tr1 is a switch (SW) for preventing an electric current from wastefully flowing in a case where the battery voltage is not read.

FIG. 29 is a diagram showing another example of the circuit configuration of the power supply voltage divider circuit. In the power supply voltage divider circuit shown in FIG. 29, when the battery voltage is read, the voltage of a CPU control signal from the system controller 104 becomes in an H state, and electric charges are discharged from a capacitor C1. Thereafter, the voltage of the CPU control signal is changed from the H state to a low-level state (called an “L state” below). Then, a measurement is made as to a time period from when the voltage of the CPU control signal is changed to the L state to when it is determined that the voltage of the input signal from the system controller 104 is in the H level. This measurement is made by use of a timer inside the system controller 104, or is made by counting a time period in terms of software.

The system controller 104 is supplied with power of a constant voltage by the power supply circuit 82. For this reason, a CMOS input level for judgment is approximately Vcc/2, and thus the determination is made at a constant voltage.

The time period is determined based on the values of the battery voltage, the resistance R4 and the capacitor C1. Since the values of the resistance R4 and the capacitor C1 are fixed, the time period is proportional to the battery voltage. Accordingly, the battery voltage is calculated from the time period.

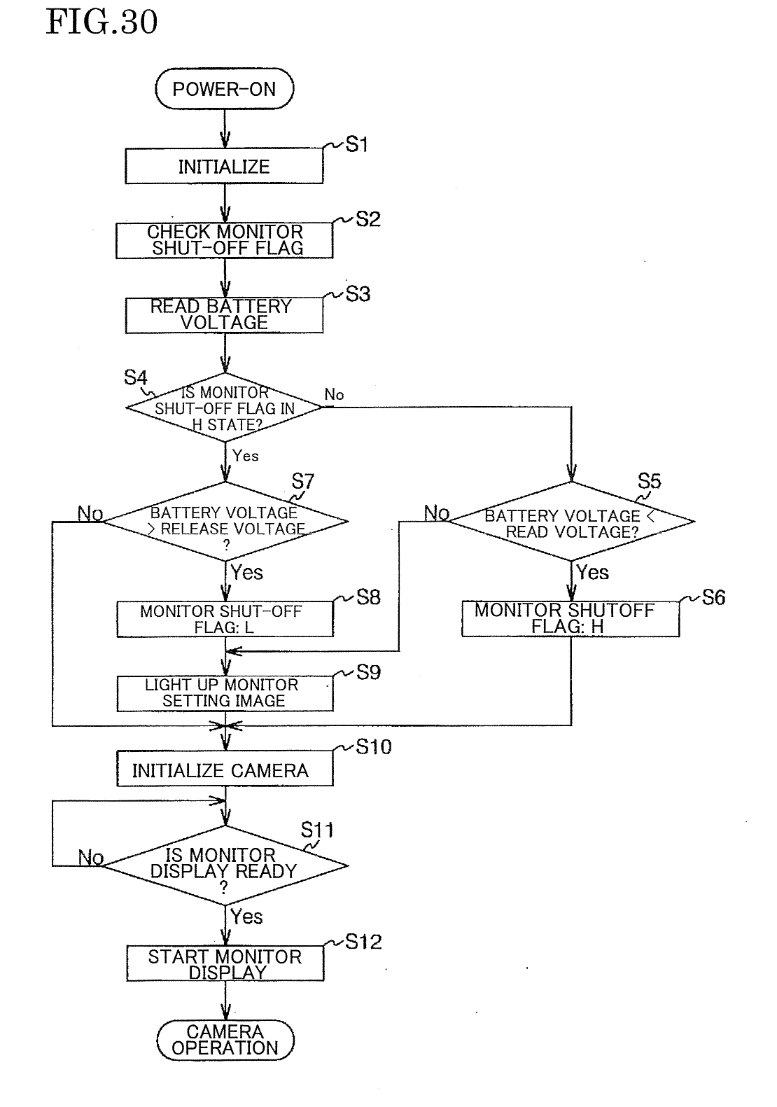

FIG. 30 is a flowchart showing an operation sequence of the digital camera 1 according to the fifth embodiment. After the digital camera 1 is powered on, the camera is initialized (step S1). Then, a monitor shut-off flag (a flag for prohibiting the monitor from being lit when the battery voltage decreases) is checked (step S2). After the monitor shutoff flag is checked, the voltage of the battery is read (step S3).

Next, a determination is made as to whether or not the monitor shut-off flag is in the H state (step S4). When the monitor shut-off flag is determined as the L state, a determination is made as to whether the value of the battery voltage is an unallowable value for lighting the monitor 13 (step S5). When the value of the battery voltage is the unallowable value for lighting the monitor 13, the monitor shut-off flag is set to the H state (step S6). In this case, nothing is displayed on the monitor 13, and the initialization of the camera is started (step S10).

On the other hand, when the monitor shut-off flag is determined as the H state in step S4, a determination is made as to whether the value of the battery voltage is larger than a voltage value allowing a release of the H state (step S7). When it is determined that the H state is to be released (step S8), a predetermined image is displayed on the monitor 13 (step S9), and then the initialization of the camera is started (step S10). Upon completion of the operations for the initialization, the monitor starts display according to a currently set camera mode (step S12).

The operations for the initialization of the camera in an image pickup mode include operations of opening a barrier, of extending a camera cone, and of displaying an image to be recorded. Moreover, the operation for the initialization of the camera in a condition setting mode includes an operation of preparing for image display for condition settings. In addition, the operation for the initialization of the camera in a monitor OFF mode includes an operation of causing the monitor 13 to be in a display OFF state.

Subsequently, in the image pickup mode after initialization, an image to be recorded is displayed by displaying an image captured by the imaging device. In the condition setting mode after initialization, the image for the condition settings is displayed. In the monitor OFF mode after initialization, the display of the monitor is turned off.

Upon completion of these operations, the digital camera becomes in a normal signal waiting state.

In the fifth embodiment, the description has been provided for the imaging apparatus, which displays a predetermined image on the monitor 13 for a period before a captured image is displayed after the camera is powered on. According to the fifth embodiment, in such imaging apparatus, when the battery voltage decreases due to consumption of the battery, a current flowing to the monitor 13 is turned off, and the current is supplied to the circuits for making the imaging apparatus ready for capturing images. Such power supply control leads to faster operations. Moreover, when the battery voltage decreases due to consumption of the battery, this control can prevent an increase of a time required for the operations (barrier opening, camera cone extension, and power application to the CCD) before a captured image is obtained after the apparatus is powered on. Moreover, by displaying an image on the monitor 13 for a period before a monitor for image pickup is displayed after the apparatus is powered on, it is possible to relieve a user concern about a delay in monitor display.

In addition, in this embodiment, messages of notices (such as a change of an internal setting from the default setting), instructions and the like can be displayed on the monitor 13 by use of a waiting time until the monitor for image pickup is displayed after the apparatus is powered on.

In addition, turning off the current flowing to the monitor 13 at a time when the battery voltage decreases prevents the battery from reaching the battery end state.

When multiple types of batteries are used in a camera, these batteries have the power supply abilities different from each other depending on the characteristics of the batteries. For this reason, a detection value corresponding to each battery to be used must be set in the camera.

By providing a certain hysteresis to each of the unallowable level and the release allowable level for reading the predetermined image, it is possible to prevent determinations on the voltage level from frequently vacillating between the unallowable level and the release allowable level. Once the battery voltage decreases to a level equal to or lower than the unallowable level, the power supply ability is still low even after the battery voltage returns to a level equal to or greater than the unallowable level. Accordingly, the camera is prevented from malfunctioning by setting the hysteresis such that it would not be determined that the battery voltage returns to the release allowable level quickly.

In general, when a battery is fresh, that is, the battery has a high remaining capacity, a decrease rate of the battery voltage is small even when a large amount of current is drawn from the battery. On the other hand, when the battery is nearly exhausted, that is, the battery has a low remaining capacity, the decrease rate of the battery voltage becomes large, which leads to a reduction in the life of the battery and an increase of a start-up time for picking up images. To cope with this, the digital camera 1 of the fifth embodiment enables the current consumption to be suppressed when the battery has a low power supply ability. Thus, even when the battery has only a low remaining capacity, the decrease rate of the battery voltage can be reduced, which makes it possible to extend the life of the battery, and also to shorten the start-up time.

Since the battery voltage recovers from the unallowable level when the battery is temporarily left out of use, the display can be performed after the battery voltage recovers from the unallowable level.

Moreover, when different types of power sources are used, the operations suitable for the respective power sources can be performed.

Furthermore, it is also possible to handle a power source characterized in that power cannot be supplied even when the voltage increases after the battery voltage recovers, once the voltage decreases.

By means of the imaging apparatus according to the embodiments of the present invention, power consumption can be reduced during operations consuming a large amount of current such as operations at a motor driving time, a memory operating time and a communication operating time, and operations under conditions of a low remaining battery capacity. This power saving is carried out by limiting the amount of current to flow to the strobe light using the semiconductor light-emitting devices and/or limiting the number of semiconductor light-emitting devices to be caused to emit light. This prevents a current consumption peak from occurring and accordingly prevents stoppage of all the operations of the apparatus, although such stoppage has heretofore occurred because the battery becomes disabled from supplying power to the apparatus due to an occurrence of the current consumption peak. Accordingly, even when the strobe light using the semiconductor light-emitting devices is used during the operations consuming a large amount of current, the apparatus can be operated for a long time.

Furthermore, according to the imaging apparatus of the embodiments of the present invention, the control unit controls the load change of the lighting unit, whereby imaging with lighting can be carried out without deteriorating the image quality of an image obtained by the imaging unit.

Although the preferred embodiments of the present invention have been described in terms of exemplary embodiments, the present invention is not limited to the embodiments. It should be appreciated that variations and changes may be made in the embodiments described by persons skilled in the art without departing from the scope of the present invention as defined by the following claims.

What is claimed is:

1. An imaging apparatus which includes a semiconductor light-emitting device functioning as a strobe light,
the imaging apparatus comprising a current limitation unit which limits a current to flow to the semiconductor light-emitting device, wherein
the current limitation unit limits the current to flow to the semiconductor light-emitting device under a predetermined condition for increasing a current consumption amount.

2. The imaging apparatus according to claim 1, wherein the predetermined condition is a motor driving time.

3. The imaging apparatus according to claim 1, wherein the predetermined condition is a memory operating time.

4. The imaging apparatus according to claim 1, wherein the predetermined condition is a communication operating time.

5. The imaging apparatus according to claim 1, wherein the predetermined condition is a time when a remaining battery capacity is low.

6. An imaging apparatus having a plurality of semiconductor light-emitting devices functioning as a strobe light, comprising a light emitting device controlling unit for controlling the number of semiconductor light-emitting devices to emit light among the plurality of semiconductor light-emitting devices, wherein
the light emitting device controlling unit controls the number of semiconductor light-emitting devices to emit light under a predetermined condition for increasing a current consumption amount.

7. The imaging apparatus according to claim 6, wherein the predetermined condition is a motor driving time.

8. The imaging apparatus according to claim 6, wherein the predetermined condition is a memory operating time.

9. The imaging apparatus according to claim 6, wherein the predetermined condition is a communication operating time.

10. The imaging apparatus according to claim 6, wherein the predetermined condition is a time when a remaining battery capacity is low.

11. An imaging apparatus comprising:
an imaging unit for picking up an image of a subject with a solid state imaging device;
a lighting unit for lighting a subject;
a controlling unit for controlling an operation of each of the imaging unit and the lighting unit; and
a power supply unit for supplying power to at least the imaging unit, the lighting unit and the controlling unit, wherein
the controlling unit controls a change of a load on the lighting unit in order to prevent deterioration of image quality of an image obtained by the imaging unit.

12. The imaging apparatus according to claim 11, wherein the controlling unit changes a power supply time for supplying power to the lighting unit

13. The imaging apparatus according to claim 12, wherein the controlling unit changes the power supply time for supplying power to the lighting unit, according to a power source state of the power supply unit.

14. The imaging apparatus according to claim 12, wherein the controlling unit changes the power supply time for supplying power to the lighting unit, according to an ambient temperature.

15. The imaging apparatus according to claim 12, wherein the controlling unit changes the power supply time for supplying power to the lighting unit, according to a state of a load on the power supply unit.

16. The imaging apparatus according to claim 12, wherein the controlling unit changes the power supply time for supplying power to the lighting unit by using a predetermined control method.

17. The imaging apparatus according to claim 12, wherein the controlling unit changes the power supply time for supplying power to the lighting unit while monitoring a change of a load on the lighting unit.

18. The imaging apparatus according to claim 12, wherein the controlling unit changes the power supply time for supplying power to the lighting unit while monitoring a change of a load on the power supply unit.

19. The imaging apparatus according to claim 11, wherein the controlling unit controls power supply to the lighting unit so that the power supply would not start or stop while the imaging unit is picking up an image.

20. The imaging apparatus according to claim 11, wherein the controlling unit controls power supply to the lighting unit so that the power supply would not start or stop while the imaging unit is transferring an image.
